(19) United States
(12) Patent Application Publication
(10) Pub. No.: US 2023/0352195 A1
(43) Pub. Date: Nov. 2, 2023

(54) Mixed Nuclear Power Conversion

(71) Applicant: Beam Alpha, Inc., West Chicago, IL (US)

(72) Inventor: Gerald Peter Jackson, Lisle, IL (US)

(73) Assignee: Beam Alpha, Inc., West Chicago, IL (US)

(21) Appl. No.: 18/025,893

(22) PCT Filed: Aug. 25, 2021
(86) PCT No.: PCT/US21/47625

§ 371 Date: Mar. 11, 2023

Related U.S. Application Data
(60) Provisional application No. 63/070,587, filed on Aug. 26, 2020.

(51) Int. Cl. G21B 3/00; G21D 5/08; G21B 1/17

(52) U.S. Cl. CPC G21B 3/006; G21D 5/08; G21B 1/17

(57) ABSTRACT

Articles of manufacture, machines, processes for using the articles and machines, processes for making the articles and machines, and products produced by the process of making, along with necessary intermediates, directed to mixed nuclear power conversion.

### I. PRIORITY

This application claims the benefit of U.S. Provisional Patent Application No. 63/070,587, Titled: “Mixed Nuclear Power Conversion,” filed Aug. 26, 2020. This U.S. Provisional Patent Application No. 63/070,587 is hereby incorporated by reference in its entirety as if fully restated herein.

### II. BACKGROUND

Nuclear fusion is generally defined as the process by which lighter nuclei are merged to form heavier nuclei. For lighter nuclei the fusion process liberates energy in the form of kinetic energy in the residual particles (also called fusion products). The vast majority of past attempts at generating electrical power from fusion reactions have contemplated boiling water to drive conventional turbines (an example of a means approximated by a Carnot cycle). These past attempts have often utilized strong magnetic fields to constrain plasmas of electrons and ions until the ions collide and fuse. Such magnetic containment is prone to instabilities and particle leakage, causing inadvertent and often catastrophic loss of energy that would otherwise be needed to sustain fusion reactions.

The electrons within the plasma present their own set of difficulties. First, because electrons are much lighter than ions, electromagnetic collisions between electrons and ions tend to rob the ions of the kinetic energy needed for the fusion process. Second, these scattered electrons tend to be relativistic, emitting photonic radiation when the collide or accelerate. This photonic radiation is also a large source of energy leakage, robbing the plasma of the energy needed to sustain fusion reactions.

There is a class of fusion reactions referred to as aneutronic. In these reactions very little of the energy liberated by the reactions is in the form of kinetic energy in neutrons. Neutrons pose several problems when contemplating widespread application of fusion-based electrical power generation. First, neutrons give up kinetic energy in the form of heat passing through very thick materials, and often escape at thermal velocities. Second, thermal neutrons pose a significant radiological risk to nearby personnel and are very difficult to shield. Third, large doses of high energy neutrons in metals cause embrittlement and dimensional changes, compromising the functionality and integrity of the reactor. Fourth, neutrons activate stable isotopes and create short-lived and long-lived radioactive isotopes that inhibit facility maintenance and disposal of equipment.

The vast majority of nuclear fusion reactors utilize a fuel composed of a mixture of the hydrogen isotopes tritium and deuterium. When a tritium nucleus (called a triton) and a deuterium nucleus (called a deuteron) collide, they sometimes undergo nuclear fusion and produce a helium nucleus (called an alpha particle), a neutron, and 14.1 MeV of energy in the form of kinetic energy of these two fusion products. This type of fusion is often referred to as DT fusion.

Tritium is a radioactive isotope of hydrogen with a half-life of 12.32 years, decaying by the emission of 5.68 keV beta particles and virtually no gamma-rays. From a radiological perspective, tritium ingestion can lead to significant radiation exposure. For example, the standard smoke detector used in homes has a 0.9 microCuries Am-241 source, a level of decay activity deemed acceptable. One gram of tritium has a decay activity of approximately 10,000 Curies, 10 billion times higher than the smoke detector.

Tritium readily migrates between hydrogen-containing compounds. When tritium molecules T2 are released into the atmosphere, instead of rising indefinitely due to its low atomic mass, the molecule quickly combines with water vapor to form the molecule HTO. Consumption of tritiated water HTO is the leading mechanism for human exposure to tritium.

Fusion reactors employing DT fusion require large inventories of tritium fuel. In addition, since tritium is very rare and not found in nature, tritium fuel needs to be “bred” in blankets composed of lithium. For large reactors such as ITER in France, tritium inventories measured in kilograms are indicated. Because isotopes of hydrogen such as tritium readily diffuse through a wide range of materials include steel pipes, tritium loss rates far beyond those traditionally deemed acceptable are expected without further innovations.

Fusion reactors employing DD fusion must address the formation of tritium. As seen in FIG. 1, tritium nuclei (tritons) [034] are formed in approximately half of the fusion reactions. An embodiment of an electrical power plant based on DD fusion, with a sulfur blanket, and a conversion efficiency of 40%, the continuous production of one megawatt of electrical power produces tritium at a rate of approximately 1 kilogram per year. If the vacuum maintained with the fusion reactor is due to roughing pumps utilizing pump oil, the above rate of tritium production yields a corresponding contamination rate of pump oil irradiation. Because the tritium half-life is over a decade, safe disposal of tritiated pump oil will be a significant and expensive problem.

Accordingly, there is a need for improvement over such past approaches.

### III. SUMMARY

The disclosure below uses different prophetic embodiments to teach the broader principles with respect to articles of manufacture, apparatuses, processes for using the articles and apparatuses, processes for making the articles and apparatuses, and products produced by the process of making, along with necessary intermediates, directed to direct nuclear power conversion. This Summary is provided to introduce the idea herein that a selection of concepts is presented in a simplified form as further described below. This Summary is not intended to identify key features or essential features of subject matter, nor this Summary intended to be used to limit the scope of claimed subject matter. Additional aspects, features, and/or advantages of examples will be indicated in part in the description which follows and, in part, will be apparent from the description, or may be learned by practice of the disclosure.

References sited herein are incorporated by reference as if fully stated herein. The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Variation from amounts specified in this teaching can be “about” or “substantially,” so as to accommodate tolerance for such as acceptable manufacturing tolerances. Variation in shapes in this teaching can also be “about” or “substantially,” so as to accommodate unimportant variations from an idealized geometric description.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

With the foregoing in mind, consider an apparatus (method of making, method of using) including a power plant [002] producing output electrical power [082] constructed so as to produce more of said output electrical power [082] than electrical power input to the apparatus. In some embodiments herein, the power plant [002]: (1) can be devoid of magnetic field(s) that constrain a plasma of said ions [028] to enable or enhance ion collisions [018]; (2) can be such that at least some of the kinetic energy of charged particles released from the fusion reaction is not converted into said output electrical power [082] by a process approximated by a Carnot cycle; (3) or can be both.

An ion is defined as an atom that is electrically charged. Such charging is accomplished by either adding or removing one or more electrons that orbit a previously neutrally charged atom. In the context of this instant application the term ion is generally defined as an atomic nucleus that has had all orbiting electrons removed.

Illustratively, consider the reaction of deuterium-deuterium (“DD”) fusion to teach the broader concepts of producing such output electrical power [082]. DD fusion can occur via two channels that occur with similar probabilities: (1) with the formation of ions of tritium [034] and hydrogen [036]; (2) with the formation of helium-3 ions [030] and a neutron [032]. Note that the formation of ions of tritium [034], hydrogen [036], and helium-3 [032] is of interest since these particles are charged, and thus their motion represents an electrical current. Similar to the use of electron motion in vacuum tubes to create amplifiers for early radios and televisions, the motion of these charged ions can be converted directly into electrical power without an intermediate step of creating steam and driving a turbine, as in a means for approximating a Carnot cycle. This method of output electrical power generation [082] is similar to that considering alpha particles taught in U.S. provisional patent application 62/811,485 filed on Feb. 27, 2019 and invented by the inventor of this instant application. This provisional patent has been converted into the international patent application PCT/US20/19449 filed on Feb. 24, 2020. Both provisional application 62/811,485 titled “Direct Nuclear Power Conversion” and international application PCT/US20/19449 titled “Direct Nuclear Power Conversion” are incorporated herein by reference as if fully stated herein.

Illustratively, the neutron [032] generated in conjunction with the helium-3 ion [030] can have its kinetic energy harvested [022] and multiplied by the use of an absorbing blanket [080] as taught in U.S. provisional patent application 63/036,029 filed on Jun. 8, 2020 and co-invented by the inventor of this instant application. This provisional patent has been converted into the international patent application PCT/US20/36092 filed on Jun. 7, 2021. Both provisional patent 63/036,029 titled “Sulfur Blanket” and international patent application PCT/US21/36092 titled “Sulfur Blanket” are incorporated herein by reference as if fully stated herein. As the neutron [032] passes through the blanket [080] the neutron [032] thermalizes, a process wherein most neutrons [032] lose their kinetic energy until they are in thermal equilibrium with the blanket [080] material. The neutron [032] kinetic energy is converted into heat, increasing the temperature of the blanket [080]. If the blanket [080] is thick enough and composed of atoms with sufficiently large nuclear capture cross section, additional thermal energy is created by neutron absorption into those large cross section nuclei. The absorption process converts potential energy (the total mass of the initial neutron [032] and nucleus via the equation E=mc²) into kinetic energy by forming a final state with lower mass and hence excess kinetic energy.

### IV. INDUSTRIAL APPLICABILITY

Industrial applicability is representatively directed to that of apparatuses and devices, articles of manufacture—particularly electrical—and processes of making and using them. Industrial applicability also includes industries engaged in the foregoing, as well as industries operating in cooperation therewith, depending on the implementation.

### V. DRAWINGS

In the non-limiting examples of the present disclosure, please consider the following:

FIG. 1 is an illustration of the two fusion channels that occur when two deuterons [028] fuse.

FIG. 2 is a graph of the measured DD fusion cross section yielding a triton [034] and a proton [036].

FIG. 3 is a graph of the measured DD fusion cross section yielding a helium-3 nucleus [030] and a neutron [032].

FIG. 4 is a graph of the calculated fusion product kinetic energies produced in DD fusion as a function of the kinetic energy of two equal energy colliding deuteron beams [026].

FIG. 5 is an illustration of elastic Coulomb scattering of two deuterons [028].

FIG. 6 is a graph of the elastic Coulomb scattering cross section for all deflections between a minimum elastic Coulomb scattering angle θ and a deflection angle of 180 degrees.

FIG. 7 is an illustration of an embodiment of an electrical power plant [002] harvesting output electrical power [082] from fusion reactions involving two deuteron beams [026].

FIG. 8 is an illustration of an embodiment of a method for producing output electrical power [082].

FIG. 9 is an illustration of an embodiment of the vacuum maintenance system of the electrical power plant [002].

FIG. 10 is an illustration of a graph of the measured secondary electron [038] yield due to bombardment of metal surfaces by protons [036].

FIG. 11 is an illustration of a graph of the measured secondary electron [038] yield due to bombardment of metal surfaces by protons [036] (open triangles) and helium ions [030] (open circles).

FIG. 12 is an illustration of a graph of the measured secondary electron [038] yield due to bombardment of a molybdenum surface by singly ionized atomic and molecular nitrogen.

FIG. 13 is an illustration of an apparatus for measuring the secondary electron [038] kinetic energy spectrum.

FIG. 14 is an illustration of a graph of the measured secondary electron [038] kinetic energy spectrum due to bombardment of a metal surface by ions.

FIG. 15 is an illustration of a graph of the measured secondary electron [038] yield due to bombardment of metal surfaces by relativistic electrons.

FIG. 16 is an illustration of a graph of the measured secondary electron [038] kinetic energy spectrum due to bombardment of metal surfaces by relativistic electrons.

FIG. 17 is an illustration of one embodiment of a means by which to electrically charge and maintain the negative voltage of the central electrode [008] of an electrical power plant [002].

FIG. 18 is an illustration of the role one embodiment of a sulfur blanket [104] plays in an electrical power plant [002].

FIG. 19 is an illustration of the natural isotope abundances and properties of various sulfur isotopes.

FIG. 20 is an illustration of the capture [024] of a neutron [032] by a sulfur-32[132] atom, resulting in the emission of gamma-rays [108] and the release of 8.64 MeV of total energy.

FIG. 21 is an illustration of sulfur blanket [104] embodiment surrounding nuclear fusion reactions [102].

FIG. 22 is an illustration of a sulfur blanket [104] embodiment modified to also function as a sulfur-sodium battery [120].

FIG. 23 is an illustration of energy storage in a sulfur-sodium battery [120].

FIG. 24 is an illustration of an electrical power plant [002] embodiment utilizing a barrier [090] comprised of a proton conductor [100].

FIG. 25 is an illustration of one embodiment of a barrier [090] comprised of a proton conductor [100] that has an inside coating [096] and an outer coating [098], said outer coating [098] being electrically conducting.

FIG. 26 is an illustration of a dependance of positively charged particle kinetic energy near a barrier [090] on deuteron beam [026] kinetic energy in the central region [014].

FIG. 27 is an illustration of helium-3 [030] DD fusion product kinetic energy as a function of deuteron beam [026] kinetic energy in an embodiment where the voltages of the outer coating [098] and the ion sources [006] are the same.

FIG. 28 is an illustration of the penetration range of helium-3 nuclei [030] into titanium and stainless steel as a function of helium-3 [030] kinetic energy.

FIG. 29 is an illustration of the penetration range of triton [034] into titanium and stainless steel as a function of triton [034] kinetic energy.

FIG. 30 is an illustration of the penetration range of proton [036] into titanium and stainless steel as a function of proton [036] kinetic energy.

FIG. 31 is an illustration of the dependence of the hydrogen diffusion coefficient in stainless steel as a function of temperature.

FIG. 32 is an illustration of hydrogen concentration in stainless steel as a function of time.

### VI. DETAILED DISCLOSURE OF MODES

The following detailed description is directed to concepts and technologies for mixed nuclear power conversion into output electrical power [082] by fusion reactions, teaching by way of prophetic illustration. The disclosure includes an apparatus comprising a power plant [002] producing output electrical power [082] in a construction to bring into collision [018] one species of ions so as to induce nuclear fusion reactions and thereby produce more of said output electrical power [082] than electrical power input to the apparatus. Similarly, the following disclosure teaches a method of generating output electrical power [082], the method comprising generating more output electrical power [082] than electrical power input to an apparatus by bringing into collision [018], in said apparatus, one species of ions so as to induce nuclear fusion reactions. These are indicative of how to make such an apparatus as well as necessary intermediates produced in the methods.

In contrast to past attempts at nuclear fusion for the purposes of output electrical power [082] generation, this disclosure teaches an apparatus wherein the power plant [002] producing [058] output electrical power [082] can be devoid of a magnetic field that constrains a plasma comprised of said ions [028] brought into said collisions [018]. It also describes a method of bringing ions [028] into collision [018] in ways that can be devoid of constraining a plasma with a magnetic field.

Moreover, this disclosure describes an apparatus [002] which absorbs neutron [032] kinetic energy and then captures said neutrons [032] in order to convert potential energy stored in a blanket [080] into additional nuclear energy available for conversion into output electrical power [082]. Similarly, this disclosure describes a method wherein the generating employs a blanket [080] which absorbs neutron [032] kinetic energy and then converts potential nuclear energy stored in the blanket [080] into additional heat for conversion into output electrical power [082].

A. Deuteron-Deuteron Fusion

One teaching embodiment for teaching broader concepts is directed to deuteron [028]-deuteron [028] (“DD”) fusion, a reaction in which a low energy neutron [032] is generated approximately half of the time, and otherwise ions of hydrogen [036], tritium [034], and helium-3 [030] are produced. DD fusion is employed herein as a prophetic teaching, recognizing that materials other than deuterium ions [028] can be fused consistent with the prophetic teaching by this example.

One embodiment for net electrical power generation (defined as excess output electrical power [082] beyond the electrical power devoted to operate the power plant [002]) utilizing fusion is to induce fusion events by colliding a beam of deuterons [026] (bare deuterium nuclei [028]) with another beam of deuterons [026]. Bare nuclei are atoms that have had all of their orbiting electrons stripped away, i.e. consisting essentially of no electrons. The absence of neutrons [032] emanating from the reactions with sufficient energy to induce undesired isotopic changes in surrounding material avoids a major source of radioactivity-induced safety and material control issues.

The above limitation of “consisting essentially of no electrons” recognizes that it is possible for nuclei to be partially ionized, meaning that not all electrons have been stripped away. There are processes in which an ion can shed or accumulate orbiting electrons via collisions and other physical phenomenon. This limitation means that while the desire is to have absolutely no electrons attached to ions, there might be a small number of electrons that exist attached to some ions, though not enough to affect the operation or process of nuclear fusion and output electrical power [082] production.

Specifically, this disclosure teaches an apparatus wherein one species of ions are brought into said collision as two deuteron beams [026] both consisting essentially of no electrons. This disclosure also teaches a method wherein the bringing into collision comprises bringing into collision one species of ions as two particle beams. both deuteron beams [26] consisting essentially of no electrons.

Note that the word species is both singular and plural. In the context of this instant application “one species of ions” means that there is only one element and only one isotope of that element involved in said collisions and fusion reactions. For example, the fusion of boron-11 nuclei and hydrogen ions (protons) involves two species of ions; the boron-11 nuclei and the protons. In DD fusion the two deuteron beams [026] are composed of one species of ions; deuterons [028].

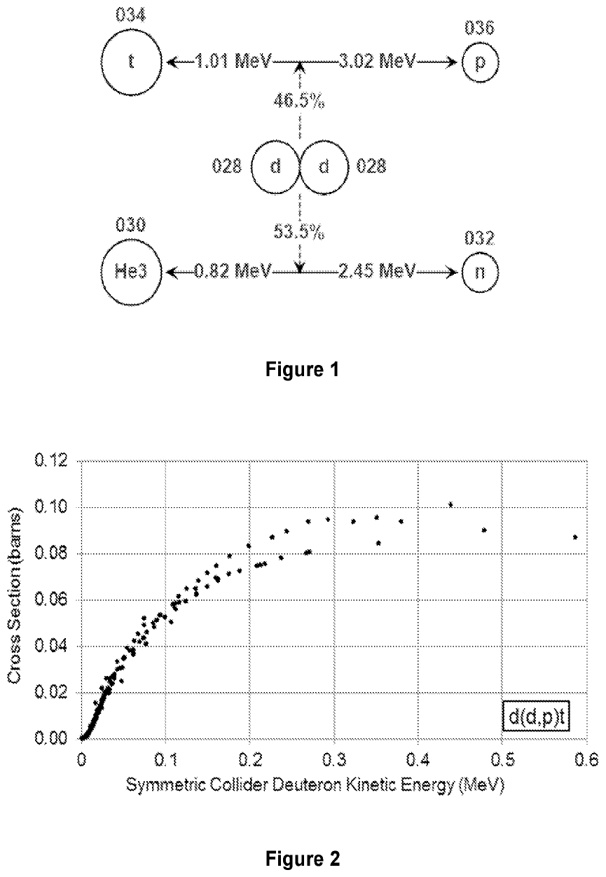

As shown in FIG. 1, when two deuterons [028] fuse one of two results occurs with similar probability. In one channel that occurs with an average probability of 46.5%, a triton [034] (tritium nucleus [034]) and a proton [036] are produced. If the deuterons [028] are at rest when they fuse, the kinetic energies of the triton [034] and proton [036] are 1.01 MeV and 3.02 MeV respectively. In the other channel that occurs with an average probability of 53.5%, a helium-3 nucleus [030] (two protons and one neutron) and a neutron [032] are produced. Again, if the deuterons [028] are at rest when they fuse, the kinetic energies of the helium-3 nucleus [030] and neutron [032] are 0.82 MeV and 2.45 MeV respectively. The kinetic energies of the fusion products (triton [034], proton [036], helium-3 nucleus [030], and neutron [032]) come from the mass difference between the initial state (two deuterons [028]) and the final state (proton [036]/triton [032] in the first channel and neutron [032]/helium-3 [030] in the second channel). The fusion products in the second channel have less kinetic energy because the neutron [032] is significantly more massive than the proton [036].

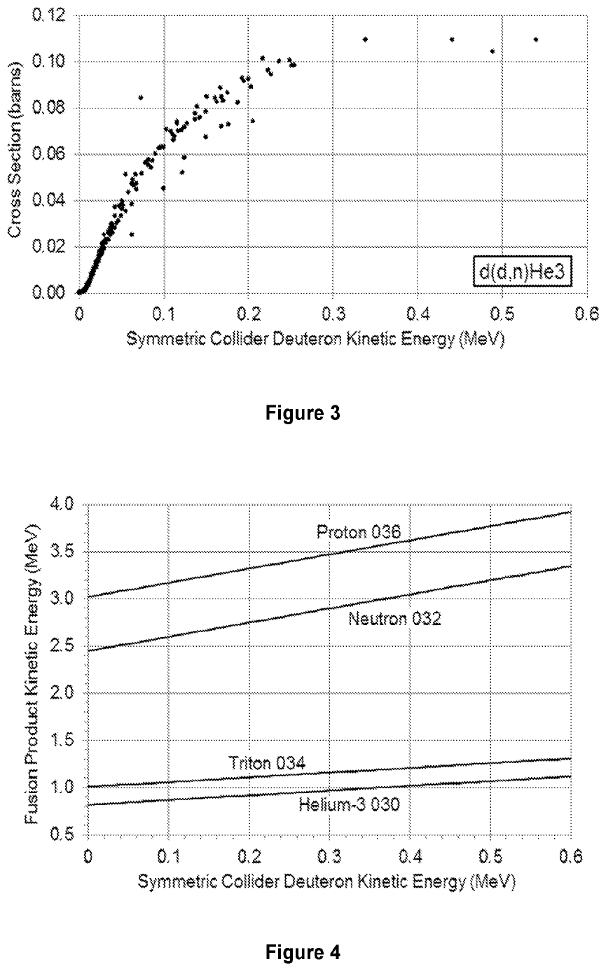

Because the two deuterons [028] each possess an electrostatic charge of one proton, they repel each other. Therefore, the probability of inducing fusion when the two deuterons [028] are at rest is vanishingly small. In order to bring the two deuterons [028] close enough together for them to fuse, they are collided [018] with sufficient relative velocity that their separation is reduced (trading kinetic energy for electromagnetic potential energy). In physics this relative velocity is often quantified in terms of kinetic energy. FIGS. 2 and 3 show the probability of DD fusion when colliding two equal kinetic energy deuteron beams [026], each with the kinetic energy on the horizontal axis. In accelerator physics a machine which collides [018] two beams [026] of equal kinetic energy is called a symmetric collider. The cross section is the measured effective area of a target for a specific nuclear reaction. When multiplied by a flux of incident particles, the cross section yields the rate at which that specific nuclear reaction takes place.

In FIG. 2 the measured cross section for the DD fusion reaction yielding a triton [034] and proton [36] is graphed. As expected, at zero kinetic energies the cross section (probability) goes to zero. As the kinetic energy of both colliding beams approaches 0.5 MeV a peak cross section is attained.

In FIG. 3 the measured cross section for the DD fusion reaction yielding a helium-3 nucleus [030] and neutron [032] is graphed. Again, at zero kinetic energies the cross section (probability) goes to zero. As the kinetic energy of both colliding beams approaches 0.5 MeV a peak cross section is attained.

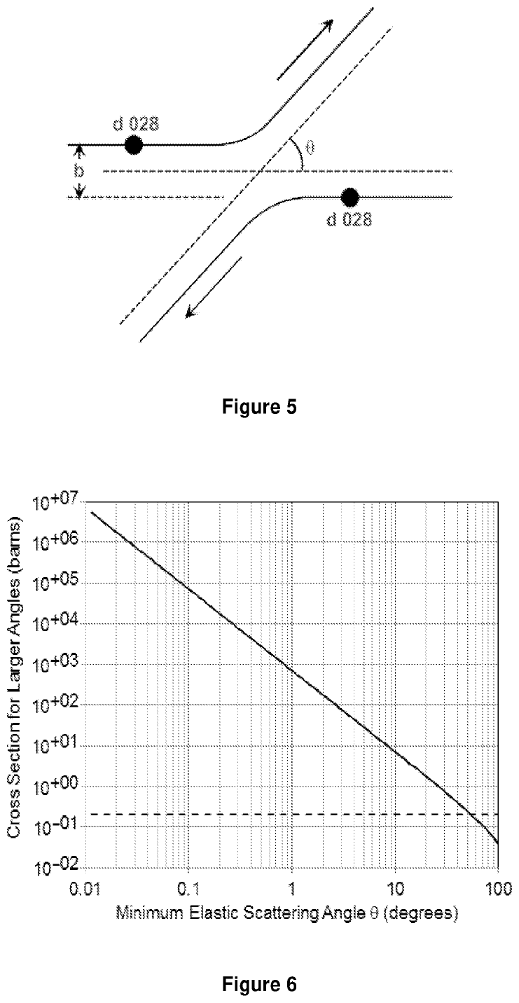

The fusion product kinetic energies indicated in FIG. 1 correspond to the specific situation where the two deuterons [028] have zero relative kinetic energy. As was discussed with respect to FIGS. 2 and 3, fusion events occur with higher probability (cross section) when the two colliding deuteron beams [026] have nonzero kinetic energies. FIG. 5 is a graph of the kinetic energies of the fusion products as a function of the symmetrically colliding deuteron beam [026] kinetic energy. Note that at zero deuteron beam [026] kinetic energy the fusion product kinetic energies are the same as those illustrated in FIG. 1.

B. Elastic Coulomb Scattering

In one embodiment the two equal kinetic energy deuteron beams [026] collide [018] head-on; that is to say that their trajectories are separated by an angle of 180 degrees. When opposing deuterons [028] fuse they generate a triton [034]/proton [036] pair of fusion product particles or a helium-3 [030]/neutron [032] pair of fusion product particles. The particles within either pair have trajectories away from each other also separated by an angle of 180 degrees. The line that these particles follow can be in any direction away from the collision point, the probability of a given direction being uniformly distributed over all angles.

A competing effect suffered by the deuterons [028] during collisions is elastic Coulomb scattering. Because each deuteron [028] is electrically charged by one proton, any two deuterons [028] approaching one another will feel a repulsive electric field. As shown in FIG. 5, this repulsive electric field has the effect of deflecting the trajectory of the two deuterons [028]. This deflection angle is represent by the symbol θ (the Greek letter Theta). The range of deflection angle is between zero and 180 degrees (backscattered). The impact parameter b is the separation of the two deuteron [028] trajectories well before they approach one another and are deflected.

In the embodiment of two equal kinetic energy deuterons [028] approaching each other from opposite directions, the two deuterons [028] leave the collision region with the same kinetic energy with which they approached (assuming no fusion takes place). This is a result of the physics principles of conservation of energy and conservation of momentum applied to electromagnetic interactions of particles. While their kinetic energy is preserved, their momenta (direction of travel) is modified.

It is well known in the art of particle physics that small angle deflections are much more probable than large angle deflections. The probability of two deuterons [028] suffering a deflection greater than some minimum elastic scattering angle θ is also quantified by a cross section. FIG. 6 is a graph of this cross section in the case of two colliding deuteron beams [026] each with a kinetic energy of 547 keV. For each minimum scattering angle on the horizontal axis this graph shows the cross section for elastic Coulomb scattering between that angle and 180 degrees. The dashed line is the combined DD fusion cross section for the two reaction channels discussed above. For example, the cross section for the deuterons [028] suffering an elastic Coulomb deflection between 55 degrees and 180 degrees is equal to the combined DD fusion cross section. This means that deuterons [028] will suffer elastic Coulomb deflections greater than 55 degrees at the same frequency that deuteron [028] undergo fusion. Similarly, the cross section for elastic Coulomb deflections between 0.6 degree and 180 degrees is approximately 2000 barns. This means that the average deuteron [028] will suffer 10,000 such small-angle deflections before it undergoes fusion.

This elastic Coulomb scattering cross section, at a given minimum angle, scales inversely as the square of the deuteron beam [026] kinetic energy. The higher the deuteron beam [026] kinetic energy, the smaller the cross section for suffering deflections of a given angle or larger. Previous attempts at DD fusion have occurred within plasmas that operate at a temperature below 1 billion degrees Kelvin. The deuteron [028] kinetic energy in a plasma of this temperature is typically on the order of 50 keV, a full order of magnitude lower than the collision energies in the embodiment foreseen in FIG. 6.

C. Fusion Reactor Architecture

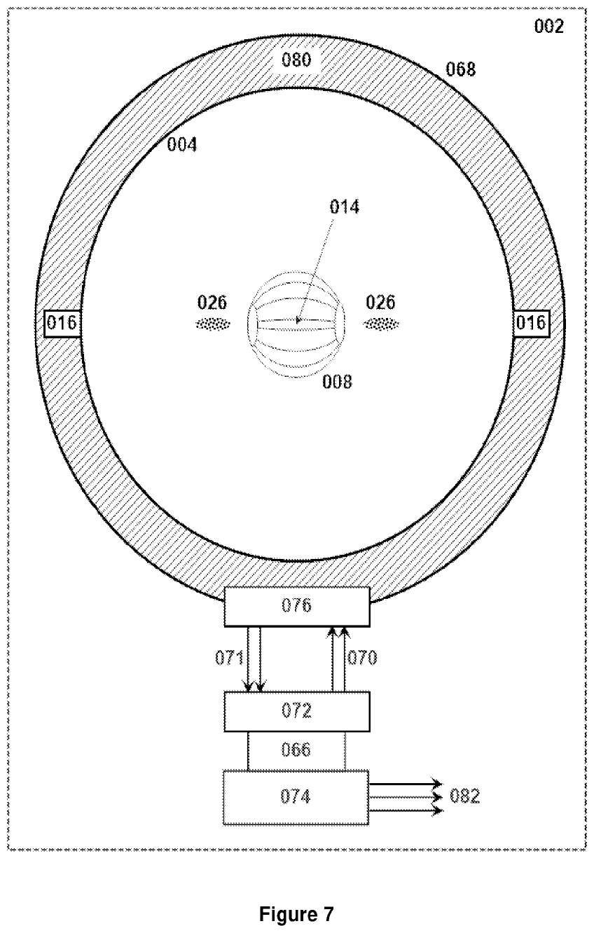

FIG. 7 illustrates an embodiment of a power plant [002] producing output electrical power [082]. A central electrode [008] is suspended inside a vacuum vessel wall [004] wherein a radial electric field is established by electrostatically charging said central electrode [008] to a negative voltage. In one embodiment the kinetic energy of the two deuteron beams [026] at the central region [014] is 547 keV. In one embodiment two deuteron sources [016] are situated adjacent to said vacuum vessel wall [004] so that two deuteron beams [026] are accelerated toward the central region [014]. At a central electrode [008] voltage of −547 kV with respect to the vacuum vessel wall [014] the two deuteron beams [026] each have a kinetic energy of 547 keV when the collide [018].

The central electrode [008] is reminiscent of an architecture invented by Philo T. Farnsworth, the inventor of television. In his case, a spherically converging electron beam was utilized to induce fusion events. His device, called the Fusor by those of ordinary skill in the art of fusion reactors, was the subject of U.S. Pat. No. 3,258,402 filed Jan. 11, 1962 titled “Electric Discharge Device for Producing Interactions between Nuclei” and number 3,386,883 filed Jun. 4, 1966 titled “Method and Apparatus for Producing Nuclear-Fusion Reactions”. Both of the patents are incorporated by reference as if as if fully stated herein. The Fusor belongs to a class of nuclear fusion reactors called Electrostatic Inertial Confinement (“EIC”).

In the case of the Fusor, a gas within a spherical vacuum chamber undergoes an arc discharge and emits electrons radially inward due to a positively charged anode within the spherical chamber. This spherical anode is permeable to electrons. Once electrons pass through the anode, they see the radial space charge force due to their spherically symmetric electron charge distribution. This repulsive force slows down entering electrons, decreasing their radial kinetic energy until all of the kinetic energy is converted into electromagnetic potential energy. The radius near which most of the electrons thereby stop their radial motion is called a virtual cathode. Electrons at the virtual cathode then accelerate radially outward again until they stop at some radius consistent with their outbound kinetic energy.

The Fusor prior art does not teach the instant application because of several key structural and operational differences that teach away from the instant application. First, in this instant application the inner wire-mesh electrode [008] is negatively charged in order to directly accelerate positive ions such as deuterons [028]. In the Fusor patent application 3,258,402 the anode electrode 21 is positively charged so as to ionize deuterium and tritium gas within the vacuum wall 20, said ionization caused by attracting and multiplying electrons generated via the ionization process itself (electron cascade). Second, in the Fusor the tritium and deuterium gas in the chamber defined by the vacuum wall 20 is the fuel that is fused. In the instant application the fuel is contained within the two deuteron beams [026] that are generated exclusively within deuteron sources [016]. Such ion sources are taught in U.S. provisional patent application 63/036,073 filed on Jun. 8, 2020 and invented by the inventor of this instant application. This provisional patent has been converted into the international patent application PCT/US21/36115 filed on Jun. 7, 2021. Both provisional patent 63/036,073 titled “Ion Source” and international patent application PCT/US21/36115 titled “Ion Source” are incorporated herein by reference as if fully stated herein. Third, the Fusor employs an anode electrode 21 power supply 50 that can accelerate the ionization electrons up to 100 keV. When the electrons form a virtual cathode the electrostatic charge of the electrons within the virtual cathode attracts the ionized tritium and deuterium. In the instant application the acceleration electrode [008] directly accelerates the deuteron beams [026]. In one embodiment the acceleration electrode [008] is charged up to voltages much higher than 100 kV. In addition, no virtual cathodes are formed in the technology taught in this instant application. Fourth, in the Fusor technology a spherical stream of ions penetrate anode electrode 21 in order to compress the ions at the center and induce fusion. In the instant application the deuterons [028] collide [018] in the central region [014] in the form of two beams [026] that are not spherical but have an initial maximum radius at injection within the vacuum vessel wall [004] less than the radius of the deuteron sources [016].

In one embodiment, this instant application teaches an electrical power plant [002] configured to produce [058] output electrical power [082] by bringing ions [028] into collisions [018], wherein the ions [028] are ions of one species, so as to induce nuclear fusion reactions and thereby produce [058] more of said output electrical power [082] than electrical power input to the electrical power plant [002], said electrical power plant [002] including: one or more sources [016] of said ions [028]; one or more negatively charged electrodes [008] constructed so as to; accelerate [010] said ions [028] to kinetic energies sufficient to induce said nuclear fusion reactions; focus [012] said ions [028] into said collisions [018] in a manner devoid of magnetic fields; and decelerate [020] positively charged particles formed by said nuclear fusion reactions; one or more blankets [080] constructed to: harvest [022] kinetic energy from neutrons [032] formed by said nuclear fusion reactions, said harvested kinetic energy converted into heat; produce additional nuclear energy by capturing [024] said neutrons [032]; convert said additional nuclear energy into additional heat within the blanket [080]; and accumulate [050] as yet additional heat any remaining kinetic energy of said positively charged particles after said positively charged particles are decelerated [020]; and a transformer configured to transform [052] said heat, said additional heat, and said yet additional heat within said blanket [080] into output electrical power [082]; said transformer including: a heat exchanger [076] that accepts water [070] and produces pressurized steam [071]; a turbine [072] that converts said steam [071] into rotational energy; and a generator [074] coupled [066] to said turbine [072] that converts said rotational energy into said output electrical power [082].

In one embodiment the apparatus taught in the preceding paragraph further includes: the ions [028] are brought into said collisions [018] as two particle beams [026], both said particle beams [026] consisting essentially of no electrons, both said particle beams [026] having about an equal average kinetic energy, both said particle beams [026] comprised of deuterons [028], and both said particle beams [026] colliding [018] at an angle of about 180 degrees.

In one embodiment this instant application teaches a process [058], the process [058] comprising: colliding [018] ions [028] of a single species so as to induce nuclear fusion reactions and thereby produce [058] more output electrical power [082] than electrical power used to cause said colliding [018]: creating said ions [028]; electrostatically accelerating [010] said ions [028] to kinetic energies sufficient to induce said nuclear fusion reactions; electrostatically focusing [012] said ions [028] into said collisions [018] in a manner devoid of magnetic fields; electrostatically recycling [054] said kinetic energies from said ions [028] that are deflected by elastic Coulomb scattering during said collisions [018]; electrostatically decelerating [020] positively charged particles formed by said nuclear fusion reactions; harvesting [022] kinetic energy from neutrons [032] formed by said nuclear fusion reactions, and converting said kinetic energy into heat; capturing [024] said neutrons [032] via additional nuclear reactions to produce excess energy, and converting the excess energy into additional heat; converting [050] remaining kinetic energy of said positively charged particles after said decelerating [020] into yet additional heat; and transforming [052] said heat, said additional heat, and said yet additional heat into output electrical power [082]; said transforming [052] comprising: heat exchanging [084] said heat into water to produce steam; spinning a turbine [086] with said steam; and turning an electrical generator [088] with said turbine. In one embodiment a product is produced by the process taught in this paragraph.

In one embodiment, this instant application also teaches a process comprising: assembling an electrical power plant [002] so that the electrical power plant [002] produces [058] output electrical power [082] by bringing ions [028] into collisions [018], wherein the ions [028] are ions of one species, so as to induce nuclear fusion reactions and thereby produce [058] more of said output electrical power [082] than electrical power input to the electrical power plant, said assembling carried out such that: there are one or more sources of said ions [028]; and one or more negatively charged electrodes [008] are located to: accelerate [010] said ions [028] to kinetic energies sufficient to induce said nuclear fusion reactions; focus [012] said ions [028] in a manner devoid of magnetic fields; and decelerate [020] positively charged particles formed by said nuclear fusion reactions; there are one or more blankets [080] constructed so as to: harvest [022] kinetic energy from neutrons [032] formed by said nuclear fusion reactions, and convert said kinetic energy into heat; produce additional nuclear energy by capturing [024] said neutrons [032], such that said additional nuclear energy is converted into additional heat within the blanket [080]; and accumulate [050] as yet additional heat any remaining kinetic energy of said positively charged particles after said positively charged particles are partially decelerated [020]; transform [052] said heat, said additional heat, and said yet additional heat within said blanket [080] into output electrical power [082], said transforming includes: a heat exchanger [076] that accepts water [070] and produces pressurized steam [071]; a turbine [072] that converts said pressurized steam [071] into rotational energy [086]; and an electrical generator [074] coupled [066] to said turbine [072] that converts said rotational energy into said output electrical power [082]. In one embodiment a product is produced by the process taught in this paragraph.

In one embodiment, this instant application also teaches a process of producing [058] output electrical power [082] comprising: colliding [018] ions [028] of one species so as to induce nuclear fusion reactions and thereby produce [058] more output electrical power [082] than electrical power used to cause said colliding [018]: creating [006] said ions [028]; electrostatically accelerating [010] said ions [028] to kinetic energies sufficient to induce said nuclear fusion reactions; electrostatically focusing [012] said ions [028] into said collisions [018] in a manner devoid of magnetic fields; electrostatically recycling [054] said kinetic energy from said ions [028] that are deflected by elastic Coulomb scattering during said collisions [018]; electrostatically decelerating [020] positively charged particles formed by said nuclear fusion reactions; harvesting [024] kinetic energy from neutrons [032] formed by said nuclear fusion reactions, converting said kinetic energy into heat; capturing [024] said neutrons [032] via additional nuclear reactions to produce excess energy, and converting the excess energy into additional heat; accumulating [050] yet additional kinetic energy of said positively charged particles that remains after said decelerating [020]; and transforming [052] said heat, said additional heat, and said yet additional heat into output electrical power [082]. In one embodiment a product is produced by the process taught in this paragraph.

In one embodiment the step of transforming [052] said heat, said additional heat, and said yet additional heat into output electrical power [082] taught in the preceding paragraph comprises: heat exchanging [084] said heat into water [070] to produce steam [071]; spinning [086] a turbine [072] with said steam [071]; and turning [088] an electrical generator [074] with said turbine [072].

D. Electrical Power Generation

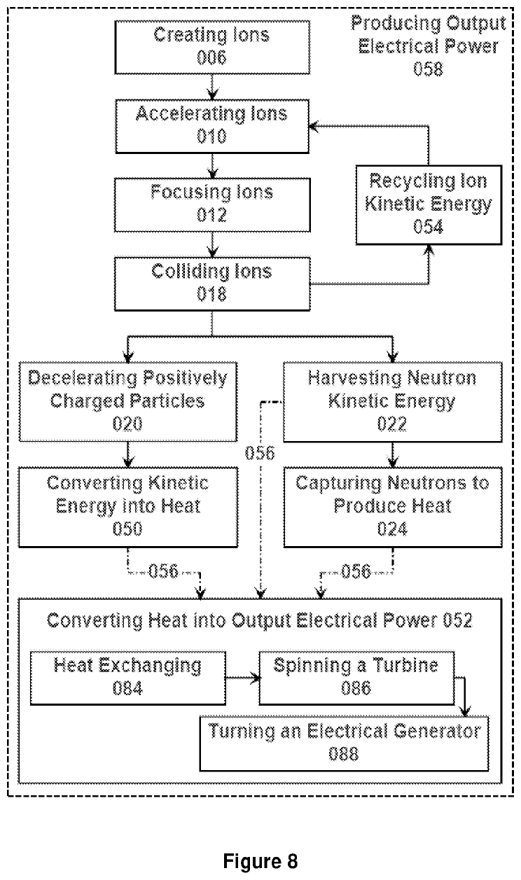

One embodiment of a power plant [002] producing [058] output electrical power [082] is illustrated in FIG. 7. A negatively charged substantially spherical central electrode [008] accelerates two deuteron beams [026] to kinetic energies sufficient for DD fusion reactions to occur at a rate indicated for output electrical power [082] generation [058]. The two deuteron beams [026] are created [006] in one or more deuteron sources [016] in electrical communication with a spherical vacuum vessel wall [004]. The central electrode [008] is substantially spherical, is permeable to said deuteron beams [026], and placed essentially concentric with said vacuum vessel wall [004]. A method [058] for producing [058] output electrical power [082] associated with this embodiment is illustrated in FIG. 8.

As a teaching embodiment, consider the situation where only one deuteron beam [026] is injected into the power plant [002] from one deuteron source [016]. The deuteron source [016] performs the step of creating ions [006]. With the central electrode [008] charged to a voltage of −547 kV with respect to a vacuum vessel wall [004], this deuteron beam [026] is accelerated to a kinetic energy of 547 keV by the time it reaches the central region [014]. The central electrode [008] performs the step of accelerating ions [010]. In this embodiment, the concentric spherical shapes of the central electrode [008] and vacuum vessel wall [004] form a radially symmetric electric field that simultaneously performs the step of focusing ions [012] into the central region [014]. The momentum of the deuteron beam [026] inside the central electrode [008] carries the deuteron beam [026] through the central electrode [008] to the other side where the deuteron beam [026] is again decelerated, trading kinetic energy for electrical potential energy. Therefore, the central electrode [008] also performs the step of recycling ion kinetic energy [054]. Assuming a good vacuum within the capabilities of those of ordinary skill in the art of accelerator physics, this deuteron beam [026] repeatedly undergoes the steps of accelerating [010], focusing [012], and recycling [054] as it oscillates indefinitely back and forth across the diameter of the vacuum vessel wall [004]. The step of creating [006] also involves injecting the deuteron beam [026] in such a way that the deuterons [028] within the deuteron beam [026] do not strike the deuteron source [016] as the deuterons [028] subsequently oscillates back and forth.

Note that in the above embodiment no energy was invested in the deuteron beams [026] in the form of initial kinetic energy. This is in contrast to other attempts at nuclear fusion wherein a plasma is heated, i.e. ion kinetic energy is increased. Because not all ions in the plasma undergo fusion immediately, and the plasma generally cools quickly because of electromagnetic radiation from plasma electrons and energetic charged particle loss, the energy invested in plasma heating has been greater than the fusion energy output within the plasma in past fusion attempts. The fusion architecture taught in this instant application overcomes this prior fatal flaw in nuclear fusion attempts at output electrical power [082] generation [058]. In this instant application the deuteron beams [026] maintain their kinetic energy at the central region [014] indefinitely without the investment of external power.

As a teaching embodiment, consider the situation where a second deuteron beam [026] is injected into the power plant [002] such that the first and second deuteron beams [026] oscillate in opposite direction, colliding [016] each oscillation at the central region [014]. At a kinetic energy of 547 keV within the central region [014] the two beams [026] pass through one another and continue their oscillations. At a rate dictated by the cross sections taught in FIGS. 2 and 3, periodically deuterons [028] of either beam [026] collide [018] and undergo DD fusion. Alternatively, at a rate dictated by the cross section spectrum taught in FIG. 6, periodically deuterons [028] of either beam undergo elastic Coulomb scattering and are deflected from their original trajectories.

In an embodiment illustrated in FIG. 7, two deuteron beams [026] oscillate back and forth across the diameter of the vacuum vessel wall [004] along a line defined by the centers of the two deuteron sources [016]. In an embodiment wherein the deuteron sources [016] have circular cross section, creating [006] circular deuteron beams [026], the radius of the deuteron beams [026] is initially less than the radius of the deuteron source [016]. As the deuteron beams [026] are accelerated [10] toward the central region [014] by the central electrode [008] the radial electric field also focusses [012] the deuteron beams [026], reducing the beam radii. The radius of the deuteron beams [026] is near a minimum at the central region [014] during the step of colliding [018].

When deuterons [028] from both deuteron beams [026] undergo one or more elastic Coulomb scattering events large enough to deflect the deuteron [028] trajectories to angles sufficiently far from the line between the two deuteron sources [016], the deuterons will come into contact with the vacuum vessel wall [004]. At this point the deuterons [028] often stick onto (or near) the inside surface of the vacuum vessel wall [004]. The process of sticking, which can involve the physics processes of adsorption, absorption, or chemisorption all involve neutralizing the deuteron [028] with an electron, forming deuterium. The deuterium atom can exist either in a molecular bond with other atoms in the vacuum vessel wall [004]. Alternatively, the deuteron can form a molecule from the group HD, D2, or DT. These hydrogen isotope molecules can be attached to (or near) the vacuum vessel wall [004] inside surface. Alternatively, these hydrogen isotope molecules can leave the vacuum vessel wall [004] and enter the vacuum within the vacuum vessel wall [004].

When the elastic Coulomb scattered deuterons [028] stick to the vacuum vessel wall [004] they have little or no kinetic energy. In an embodiment where the deuteron source [028] is electrically shorted to the vacuum vessel wall [004] (a specific form of electrical communication), no work (voltage difference times electrical charge) was performed during the life of the deuteron [028]. In other words, no power needed to be invested into the deuteron [028] to accelerate [010] it to DD fusion energies. This recovery of ion kinetic energy involving elastic Coulomb scattered deuterons [028] is another form of the step of recycling ion kinetic energy [054].

As discussed above, in prior attempts at power plants [002] designed to produce output electrical power [082] employing plasmas constrained by magnetic fields, energy was invested to heat the plasma to temperatures indicated to achieve nuclear fusion. In this instant application conservation of energy also needs to be observed, but in this case the recovery of collision kinetic energy is performed by harvesting that energy from the charged particles emanating from the fusion reaction. In other words, energy indicated to maintain power plant [002] fusion reactions is recovered for those deuterons [028] that undergo nuclear fusion, the kinetic energy of the electrically charged fusion products being harvested for that energy.

In an embodiment where the central electrode is charged to a voltage of −547 kV, the initial kinetic energies of the tritons [034]. helium-3 nuclei [030], and protons [036] inside the central electrode [008] are 1284 keV, 1094 keV, and 3843 keV respectively. The neutron [032] formed with the helium-3 nucleus [030] has a kinetic energy of 3270 keV. These values are graphed in FIG. 4. For a central electrode [008] permeable to these charged particles, the charged particles are decelerated [020] by the time their radially diverging trajectories take them to the vacuum vessel wall [004]. At the wall these kinetic energies are reduced to 737 keV, 0 keV, and 3296 keV respectively.

In the DD fusion channel forming the helium-3 nucleus [030] and a neutron [032], the helium-3 nucleus [030] reaches the vacuum vessel wall [004] with no kinetic energy, similar to the case of the elastic Coulomb scattered deuterons [028]. By similar mechanisms, the helium-3 nuclei [030] are converted into an isotope of helium gas (pick up two orbiting electrons to form neutral noble gas atoms. The amount of energy recovered by the deceleration of a helium-3 nucleus [030] is 1094 keV, which is precisely the combined kinetic energy of the two deuterons [028]. The physics principle of conservation of energy is observed. The neutron [032] kinetic energy that enters the blanket [080] is 3270 keV, which is the total energy gain from that fusion channel indicated in FIG. 1.

In the DD fusion channel forming a triton [034] and proton [036] the total kinetic energy reduction of both particles travelling toward the vacuum vessel wall [004] is 1094 keV, which is again precisely the combined kinetic energy of the two deuterons [028]. Again, the physics principle of conservation of energy is observed. The remaining total kinetic energy of 4030 keV that this pair of charged particles possess upon striking the wall is the total energy gain from that fusion channel indicated in FIG. 1.

The range of the 737 keV triton and 3296 keV proton penetrating the vacuum vessel wall [004] is generally shorter than the thickness of the vacuum vessel wall [004]. In such an embodiment all of their kinetic energy is converted into thermal energy (heat) in the vacuum vessel wall [004]. This is the step of converting kinetic energy into heat [050]. In an embodiment wherein the blanket [080] is in thermal communication [056] with the vacuum vessel wall [004], the heat deposited into the vacuum vessel wall [004] is communicated [056] to the blanket [080].

As taught further below, the blanket [080] harvests the kinetic energy of the neutron [032] emanating from the DD fusion reaction through collisions [018] of the neutron [032] with atoms within the blanket [080] material. This step of harvesting of neutron kinetic energy [022] occurs until the neutron [032] approaches thermal equilibrium with the blanket [080] material.

In an embodiment wherein the blanket [080] is composed of atoms that exhibit a large cross section for neutron [032] capture [024], neutron [032] capture [024] creates new isotopes within the blanket [080]. Neutron [032] capture [024] is another type of nuclear reaction in addition to those such as nuclear fission and nuclear fusion. When those new isotopes have a mass smaller than the combined mass of the initial nucleus and the neutron [032], energy is released in the form of photons or energetic particles. Absorption of these photons and accumulating [050] residual kinetic energy of the energetic particles within the blanket [080] complete the step of capturing [024] neutrons [032] to produce heat.

In one embodiment, the step of converting heat into output electrical power [052] starts with a heat exchanger [076] in thermal contact with the blanket [080]. By heating a cooling liquid [070] in the heat exchanger [076] to form a high pressure vapor [071], a converter [072] converts the mechanical potential energy of the vapor [071] into output electrical power [082] in an electrical generator [074] connected to said converter [072] by a coupler [066]. The efficiency of the step of converting heat into output electrical power [052] is enhanced by surrounding the blanket [080] with thermal insulation [068].

In one embodiment the cooling liquid [070] is water, the high pressure vapor [071] is steam, the converter [072] is a turbine, the coupler [066] is a drive shaft, and the electrical generator [074] is a standard electrical generator or alternator. In another embodiment the converter [072] is a thermoelectric element, the coupler [066] is copper wire, and the electrical generator is a DC-AC converter.

E. Vacuum Maintenance

Throughout the previous section teaching electrical power generation the elastic Coulomb scattered deuterons [028], the helium-3 nuclei [030], the tritons [034], and protons [036] are all absorbed when they come into contact with either the vacuum vessel wall [004], the central electrode [008], or any other surface. When striking such surfaces, these positively charged particles penetrate a short depth into the material. Once they stop (due to collision with electrons in the material), these charged particles each pick up electrons to become neutral atoms. In all cases these neutral atoms exist in gaseous form at or above room temperature. Eventually this gas diffuses out of the material into the vacuum within the vacuum vessel wall [004]. After bouncing around for a while, the gas is eventually pumped out of the vacuum vessel wall [004] via ports [040] connected to vacuum pumps.

One embodiment of vacuum pumps capable of pumping isotopes of hydrogen and helium are ion (or ion-sputter) pumps [044]. In standard ion pumps [044], every pumped hydrogen or helium isotope atom represents a current of one electron into 5 kV. Therefore, per fusion event, the pump will consume electrical energy of 1e×5 kV=5 keV for the helium-3 production channel (since the helium-3 gas is only singly-ionized in a ion pump [044], 2e×5 kV=10 keV for the triton production channel (since both the tritium and hydrogen gas are ionized in the ion pump [044]), and therefore an average of 7.33 keV per fusion event. As taught in the previous section the average energy gain per DD fusion event is 3620 keV. Therefore, in this embodiment the net output electrical power [082] of the power plant [002] is depressed by 7.33 keV/3620 keV or 0.2%.

Hence, in one embodiment the power plant [002] includes at least one ion sputter vacuum pump [044] and a spherical vacuum vessel containing a vacuum and comprising a vacuum vessel central region [014] and a vacuum vessel wall [004]. In one embodiment of a power plant [002] said ions are brought into said collisions [018] in a vacuum maintained by one or more ion-sputter pumps [044]. Another embodiment is a method of generating electrical power, including evacuating a spherical volume [002], having a vacuum vessel wall [004], to produce a vacuum sufficient to enable storage of said ion beams, wherein said evacuating includes evacuating with an ion sputter vacuum pump [044].

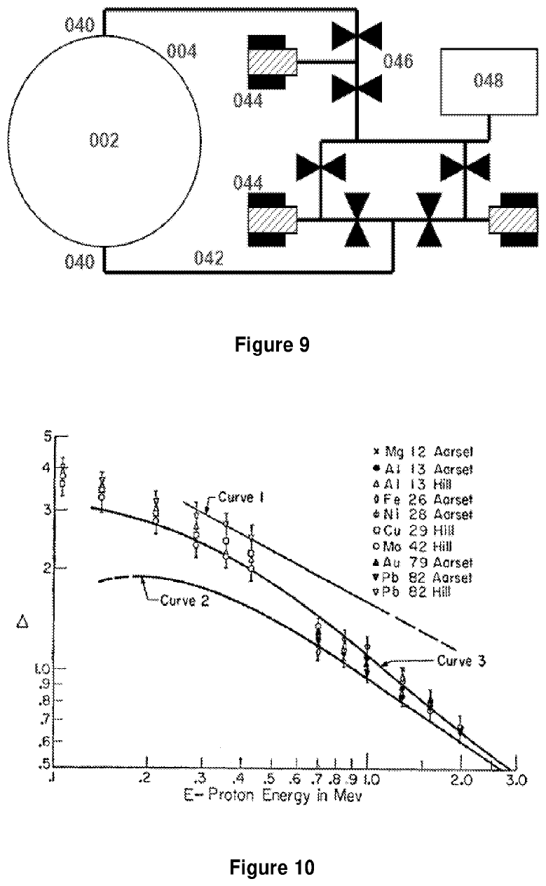

Ion pumps [044] cannot pump helium and hydrogen isotopes indefinitely. Eventually they saturate the titanium getter plates within the ion pumps [044] and outgas at a rate comparable to the pumping rate. In order to overcome this limitation, each ion pump [044] is arranged to be isolated from the power plant [002] vacuum vessel by vacuum valves [046]. When these valves are closed, the Penning cell magnets around the ion pump chamber are removed and the pump [044] chamber is heated. Another valve [046] is opened which allows the outgassing helium and hydrogen isotopes to be removed by a roughing pump [048] via a vacuum line [042]. This roughing pump [048] can be a mechanical pump (such as a turbomolectular pump) or a cryogenic trap. This embodiment of the vacuum maintenance system of the power plant [002] is illustrated in FIG. 9.

In one embodiment, the power plant [002] includes: a vacuum vessel that has a substantially spherical shape, a vessel wall [004], and a central region [014], the vacuum vessel structured to contain a vacuum; said negatively charged electrodes [008] constructed as a central, substantially spherical, electrode assembly concentric with said vacuum vessel wall [004], structured to repeatedly collide [018] said particle beams [026] with each other in said central region [014] of said vacuum vessel; an electrode charger configured to maintain the voltage of said central electrode [008]; at least one ion sputter vacuum pump [044].

F. Secondary Electron Emission

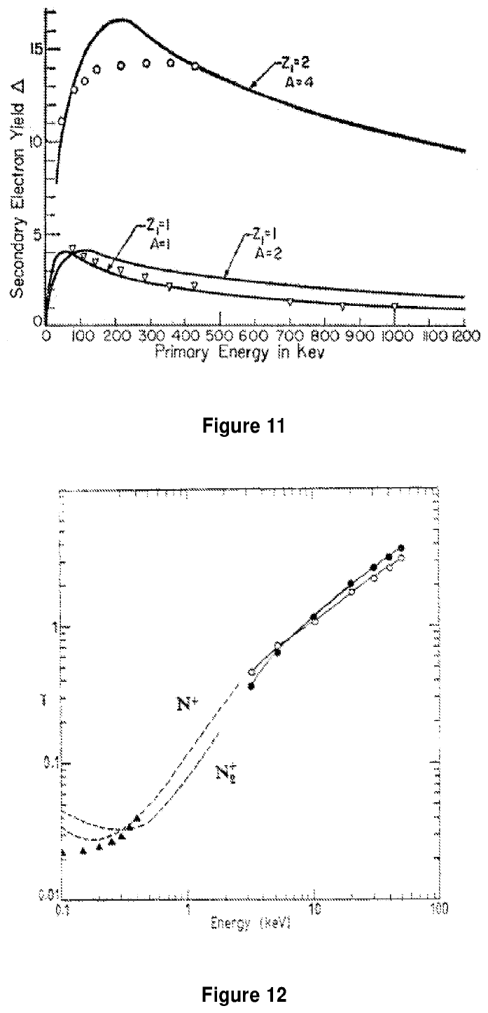

When electrons or ions of sufficient kinetic energy bombard a metallic surface, secondary electron [038] emission is observed. The ratio of observed secondary electrons [038] per incident electron or ion, termed secondary electron yield A (the Greek symbol capital delta), is a function of kinetic energy, ion charge, ion mass, and the composition of the material undergoing bombardment. In the case of hydrogen ions on a variety of metal surfaces, FIG. 10 shows the proton kinetic energy dependence of the secondary electron [038] yield. This data was presented in the paper “Theory of Secondary Electron Emission by High-Speed Ions” by E. J. Sternglass published in Physical Review, volume 108, issue no. 1, pages 1-12 on Oct. 1, 1957. The data plotted in FIG. 11 for helium bombardment was also presented in the same paper. This paper is incorporated herein by reference as part of U.S. provisional patent application 62/995,168 that was previously incorporated by reference above.

Hydrogen ions (protons [036], tritons [034], and elastic Coulomb scattered deuterons [028]) and helium ions (helium-3 nuclei [030]) are the two species of ions that will bombard the central electrode [008] and the vacuum vessel wall [004] in FIG. 7. Data relevant to heavier ions and lower kinetic energies is graphed in FIG. 12, and was taken from the paper “Electron Emission from Molybdenum Under Ion Bombardment” by J. Ferron et. al. published in Journal of Physics D: Applied Physics, volume 14, pages 1707-20 in 1981. FIG. 12 shows the secondary electron [038] yield of molybdenum undergoing bombardment by atomic and molecular nitrogen. This paper is incorporated herein by reference as part of U.S. provisional patent application 62/995,168 previously incorporated by reference above.

In one embodiment, the vacuum vessel wall [004] of the power plant [002] is comprised, or is consisting essentially, of stainless steel. In another embodiment, the vacuum vessel wall [004] is comprised, or is consisting essentially, of titanium. In yet another embodiment, the vacuum vessel wall [004] is comprised, or is consisting essentially, of aluminum.

In one embodiment a coating is placed on the inside surface of the vacuum vessel wall [004] and/or the central electrode [008] to inhibit secondary electrons [038], secondary ions, or both. In another embodiment a coating is placed on the inside surface of the vacuum vessel wall [004] to inhibit desorption of gas, inhibit outgassing due to ion bombardment, and/or to improve vacuum by providing a getter surface.

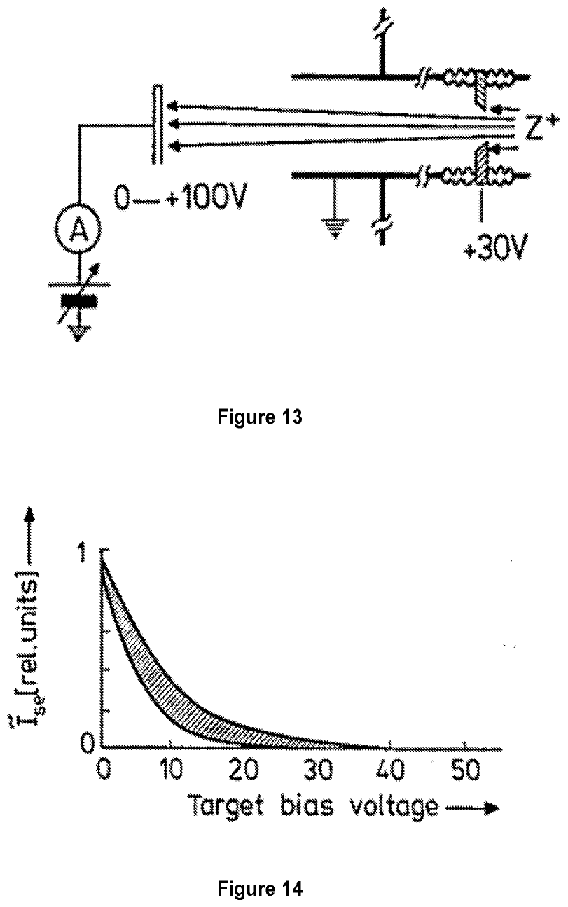

When helium-3 nuclei [030] strike the central electrode [008] and/or the vacuum vessel wall [004], secondary electrons [038] are generated as expected given the data in FIG. 11. The kinetic energy spectrum of the secondary electrons [038] is less than 100 eV, as indicated from previous measurements such as those shown in FIG. 14. The data in FIG. 14 and the illustration in FIG. 13 were reproduced from the paper “Secondary Electron Yields from Clean Polycrystalline Metal Surfaces Bombarded by 5-20 keV Hydrogen or Noble Gas Ions” by P C Zalm and L. J. Beckers published in the Phillips Journal of Research, volume 39, pages 61-76 in 1984. This paper is incorporated herein by reference as part of U.S. provisional patent application 62/995,168 previously incorporated by reference above.

The apparatus illustrated in FIG. 13 was used to measure the kinetic energy distribution. The electric field between the ion source to the right and the surface emitting secondary electrons [038] on the left will turn around the lower energy electrons before those secondary electrons [038] are lost on the grounded ion source tube. The higher the voltage creating this electric field, the smaller the measured electron current will become. At some voltage no secondary electrons [038] will have sufficient kinetic energy to reach the ion source tube.

The data graphed in FIG. 14 shows this trend. Note that when a voltage of 40 V is imposed, no secondary electron [038] current is observed. This means that the maximum kinetic energy of the secondary electrons [038] is approximately 40 electron volts.

The geometry of the power plant [002] of this instant application is functionally analogous to the apparatus in FIG. 13. The negative voltage of the central electrode [008] creates an electric field that pushes any secondary electrons emitted from the vacuum vessel wall [004] back into the wall [004]. Therefore secondary electron emission [038] from the vacuum wall [004] has no effect on power plant [002] operations.

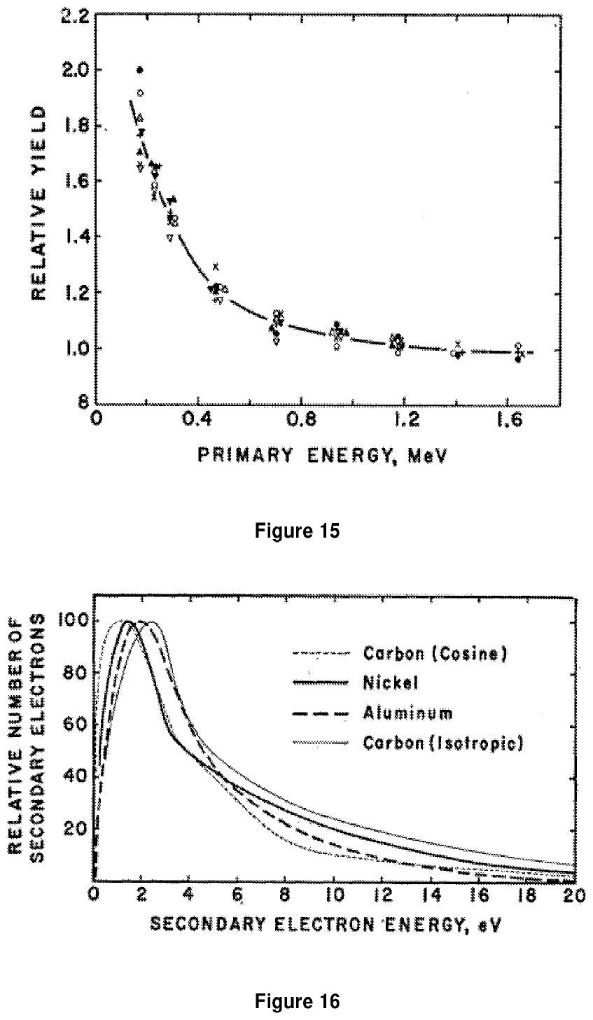

When isotopes of hydrogen and helium strike the central electrode [008], the secondary electrons [038] see an accelerating radial electric field toward the vacuum vessel wall [004]. Even secondary electrons [038] which are created with a kinetic energy infinitesimally small are accelerated to 574 keV by the time the secondary electrons [038] bombard the vacuum vessel wall [004]. FIGS. 15 and 16 contain data presented in the paper “Secondary Electron Emission Produced by Relativistic Primary Electrons” by A. A. Schultz and M. A. Pomerantz published in The Physical Review, volume 130, issue no. 6, pages 2135-41 on Jun. 15, 1963. This paper is incorporated herein by reference as part of U.S. provisional patent application 62/995,168 previously incorporated by reference above.

FIG. 15 shows that there is on average at least one secondary electron [038], and as many as two secondary electrons [038], for every electron that strikes a metal surface at kinetic energies of 574 keV and below. FIG. 16 is a graph of kinetic energy spectrum of those secondary electrons [038]. As in the case of secondary electrons [038] liberated through ion bombardment, secondary electrons [038] kinetic energy emitted due to high-energy electron bombardment is also relatively small, again less than 40 eV.

The data in FIGS. 15 and 16 again indicate that secondary electrons emitted from the vacuum vessel wall [004] are not energetic enough to reach the central electrode [008. Therefore secondary electron emission from the vacuum vessel wall [004] again has no effect on power plant [002] operations.

On the other hand, these secondary electrons emanating from the central electrode [008] and transported to the vacuum vessel wall [004] represent an electrical power drain, or partial short circuit. As taught in FIG. 11, the worst case incident is for helium-3 nuclei [030] striking the surface of the central electrode [008]. One means of mitigating this problem is to form the central electrode [008] from an array of intersecting high-energy electron beams, wherein the probability of collision between those electron beams and ions would be vanishingly small. In another embodiment that central electrode is constructed such that the average probability of an ion striking a surface of the central electrode [008] is 5%. According to FIG. 11 there is an average of approximately 10 secondary electrons [038] generated per incident 1094 keV helium-3 nucleus [030]. For an average fusion event this number of secondary electrons [038] reaching the vacuum vessel wall would be 0.535 (fraction of DD fusion events resulting in a helium-3 nucleus [030]) times 0.05 (probability of striking the central electrode [008]) times 10 (number of secondary electrons [038] per strike), or 0.27 secondary electrons [038]. This set of facts would predict that such a power plant [002] embodiment would generate net positive output electrical power [082], but with an efficiency reduced by almost 30%.

Methods of secondary electron [038] emission suppression include increased surface roughness, locally-shaped electric fields, imposition of magnetic fields, and coatings. For coatings, surface coatings such as carbon and titanium nitride are specifically indicated.

In one embodiment metal wires forming the central electrode [008] are coated with a carbon coating, the carbon being in the form a diamond, graphite, carbon nitride, or some other carbon-containing compound. Carbon can be used to suppress secondary electron emission yield by a factor of five. In another embodiment the wires forming the central electrode [008] are comprised of carbon fibers bound together into a composite structure. In another embodiment the wires forming the central electrode [008] have a surface which has been roughened or structured in such a way to minimize secondary electron [038] emission. In another embodiment the wire forming the central electrode [008] is shaped in order to minimize secondary electron emission [038]. In another embodiment the wire forming the central electrode [008] has a permanent magnetization of sufficient shape and magnitude to minimize secondary electron emission [038] yield. In another embodiment a magnetic field is generated in close proximity of the central electrode [008] surfaces by running electrical current through said wires. In another embodiment a plurality of surface roughness, coatings, locally-shaped electric fields, and magnetic fields are used together to minimize secondary electron [038] yield.

G. Central Electrode Power Supply

As taught earlier, in one embodiment the consumption of electrical power in ion pumps [044] is indicated in order to maintain the vacuum within the vacuum vessel walls [004], hence maintaining power plant [002] production of output electrical power [082]. Another function within said power plant [002] where the consumption of electrical power is indicated in order to maintain production of output electrical power [082] is the ionization of deuterium gas within the deuterium sources [016] when creating [006] deuteron beams [026].

In one embodiment the process of deuterium ionization is performed via the bombardment of low-pressure deuterium gas with energetic electrons. Creating [006] ions in this manner is taught in U.S. provisional patent application 63/036,073 filed on Jun. 8, 2020 and invented by the inventor of this instant application. This provisional patent has been converted into the international patent application PCT/US21/36115 filed on Jun. 7, 2021. Both provisional patent 63/036,073 titled “Ion Source” and international patent application PCT/US21/36115 titled “Ion Source” are incorporated herein by reference as if fully stated herein.

A third function within said power plant [002] where the consumption of electrical power is indicated in order to maintain production of output electrical power [082] is the regulation of the electrical charge on the central electrode [008]. As taught earlier in this instant application, charged particles can strike the central electrode [008], causing the emission of secondary electrons [038]. These secondary electrons [038] are accelerated toward the vacuum vessel wall [004] by the electric field associated with the negative voltage of the central electrode [008]. One or more power supplies [078] feeding replacement electrons into the central electrode [008] are indicated.

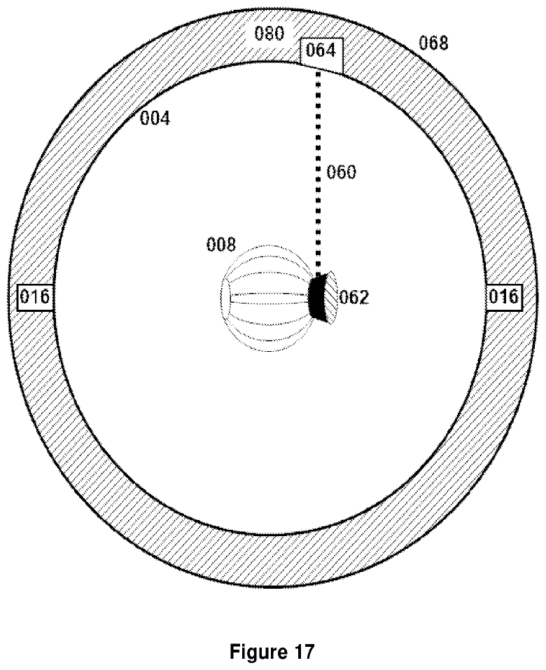

FIG. 17 contains an illustration of one embodiment of a central electrode [008] charging system. First, one or more electron charging accelerators [064] inject one or more streams (or beams) of charging electrons [060] into the vacuum chamber with a kinetic energy capable of reaching one or more electron charging targets [062] connected to one or more negatively charged central electrodes [008]. In the embodiment represented by FIG. 17 an electron target is hollow along the direction of the deuteron beam [026], with a surface tapered toward the central region [014] so as to present the maximum permeability (minimum opacity) to the charged particles emanating from DD fusion reactions occurring at the central region [014]. In an embodiment wherein the electron accelerators [064] are electrically shorted to the vacuum chamber wall [004], the kinetic energy of the charging electron beams [060] is equal to or greater than the voltage difference between a central electrode [008] and the vacuum chamber wall [004]. In an embodiment where the central electrode [008] has a voltage of −574 kV with respect to the vacuum chamber wall [004] the electron beam [060] kinetic energy emitted by the electron charging accelerator [066] is equal to or greater than 574 keV.

When secondary electrons [038] are ejected from the central electrode [008] set at a voltage of −574 kV with respect to the vacuum chamber wall [004], those secondary electrons [038] each deposit 574 keV of thermal energy into the vacuum chamber wall [002]. That thermal energy is then transported [056] to the blanket [080]. In one embodiment the thermal energy is subsequently transport to the heat exchanger [076] before being converted [052] into output electrical power [082]. The electron charging accelerators [064] siphon electrical power from the output electrical power [082] to power the electron accelerator [064], transforming that siphoned power into electron beam [060] kinetic energy. If the conversion efficiency of the steps of converting [052] and transforming electrical power into electron beam [060] kinetic energy were each 100%, then no reduction in output electrical power [082] would be suffered by the power plant [002]. In reality neither of these efficiencies are 100%, so for a reasonable efficiency of 40% in some embodiments a small amount of output electrical power [082] reduction is to be expected due to secondary electron [038] emission from the central electrode [008].

H. Sulfur Blanket

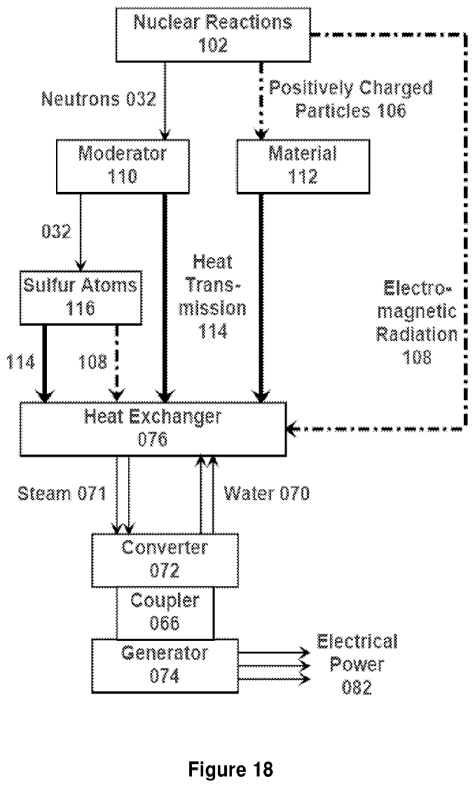

One teaching embodiment for teaching broader concepts is directed to a method of harvesting energy from neutrons [032] with a sulfur blanket [104] surrounding a region in which neutrons [032] created, sometimes in conjunction with the creation of positively charged particles [106] and electromagnetic radiation [008]. Electromagnetic radiation [108] is generally defined as electrons [154], positrons [156], and gamma-rays [158] across the entire electromagnetic spectrum. The process of creating neutrons [032] and the subsequent method of harvesting [022] energy from said neutrons [032], positively charged particles [106], and electromagnetic radiation [108] is illustrated in FIG. 18.

Upon striking the vacuum vessel wall [004] the neutrons [032] generally undergo a process of moderating [022] wherein the kinetic energy carried by the neutrons [032] is reduced. The lost kinetic energy is generally converted into heat [116] and subsequent heat transmission [114]. The vast majority of neutrons [032] undergo the process of moderating [022] before they undergo a subsequent process of capturing [024], wherein a neutron [032] is absorbed by an atom via nucleon exchange reactions such as neutron [032] capture [024] with a subsequent emission of a gamma-ray [158] (referred to as a (n,g) reaction. Other relevant neutron [032] capture [024] channels are neutron-proton (n,p) and neutron-alpha (n,a) exchanges (alpha particles are helium-4 nuclei). It is sometime possible for the capturing [024] process by an atom to be immediately preceded by transfer of neutron [032] kinetic energy to that same atom, also deemed moderating [022]. The process of capturing [024] generates more heat and subsequent heat transmission [114] and additional electromagnetic radiation [108].

In parallel, the process of nuclear reactions [102] may also generate positively charged particles [106]. These positively charged particles will generally undergo the process of stopping [050], wherein the kinetic energy lost by the positively charged particles is also converted into heat and subsequent heat transmission [114]. The heat transmission [114] and electromagnetic radiation [108] are all then subjected to the process of heat exchanging [084] with a heat exchanger [076].

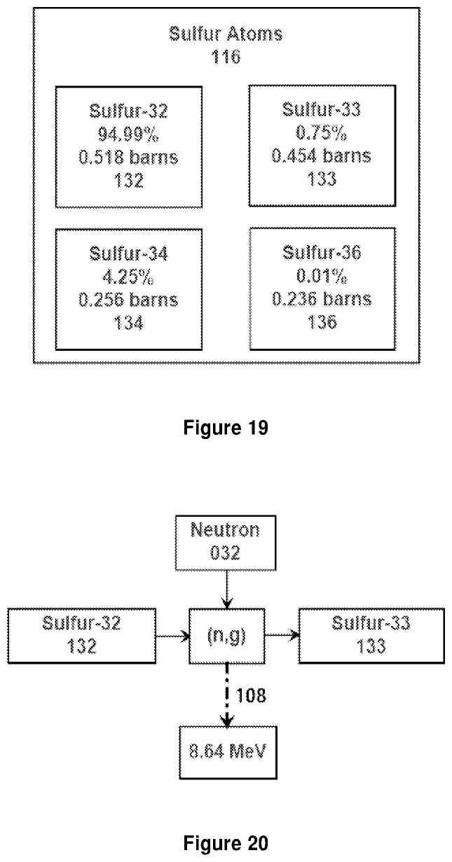

In one embodiment, a prophetic teaching, sulfur atoms [116] are used for the step of capturing [024] neutrons [032]. FIG. 19 illustrates the abundances and thermal neutron cross sections for stable isotopes found on Earth. Note that the vast majority of naturally occurring sulfur is composed of the isotope sulfur-32 [132]. Most of the remaining naturally occurring sulfur is in the form of isotope sulfur-34 [134]. The isotopes sulfur-33 [1313] and sulfur-35 [135] are only found in trace amounts in nature.

The thermal neutron cross sections specified in FIG. 3 are determined by the capturing [024] of neutrons [032] in thermal equilibrium with sulfur atoms [116] at room temperature. The cross section is proportional to the probability of a neutron [032] being absorbed (capturing [024]) by an atom. Room temperature corresponds to a typical neutron kinetic energy of 0.025 eV.

The prophetic embodiment wherein sulfur atoms [116] are involved in capturing [024] neutrons [032] is of interest because of the large energy release that occurs. As illustrated in FIG. 20 for the case of sulfur-32 [132] capturing [024] neutrons [032], the result is the generation of sulfur-33 [133] and the emission of electromagnetic radiation [108]. The mass difference between the initial state (a free neutron [032] and a sulfur-32 [132] atom) and final state (a sulfur-33 [133] atom) is 8.64 MeV/c2. According to the principle of energy conservation and the famous equation E=mc2, the amount of electromagnetic radiation [108] is equal to this mass difference, or 8.64 MeV. This electromagnetic radiation [108] is then absorbed within the sulfur blanket [104], producing additional heat.

Because isotopic separation or isotopic enrichment is typically an expensive process, an embodiment is to perform the step of capturing [024] with naturally occurring sulfur atoms [116]. In this case capturing [024] is performed with sulfur atoms [116] consisting of (or in some cases, having or consisting essentially of) the isotopes sulfur-32 [132], sulfur-33 [133], sulfur-34 [134], and sulfur-36 [136]. Because of its simplicity, an embodiment is to perform the step of moderating [022] also with sulfur atoms [116].

The moderating [022] of neutrons [032] removes kinetic energy from the neutrons [032] imparted by the DD fusion process. This lost kinetic energy is converted into heat and subsequent heat transmission [114]. The electromagnetic radiation [108] from DD fusion and the capturing [024] step is completely or partially absorbed by the sulfur atoms [116], converting the electromagnetic radiation [108] into heat and subsequent heat transmission [114]. The stopping [050] of positively charged particles emitted by DD fusion converts the residual positively charged particle kinetic energy into heat and subsequent heat transmission [114]. Some or all of this heat transmission [114] and remaining (unconverted) electromagnetic radiation [108] is accumulated in a heat exchanging [084] process in a heat exchanger [076].

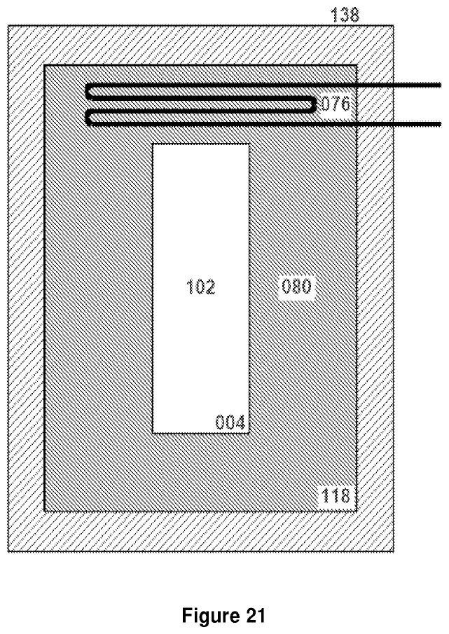

In one embodiment illustrated in FIG. 21, the sulfur blanket [080] is in the form of molten sulfur. The heat and electromagnetic radiation [108] from DD fusion reactions, stopping [050], moderating [022], and capturing [024] is deposited into the molten sulfur. The purpose heat exchanging [084] in a heat exchanger [076] is to remove this heat from the sulfur blanket [104], boiling liquid water [070] to produce high pressure steam [071]. In one embodiment the molten sulfur within the sulfur blanket [080] undergoes thermal convection, and heat exchanger [076] pipes containing flowing water [070] near the top of the sulfur blanket remove heat from the sulfur blanket [080] and deliver it into the water [070] to produce steam [071]. The high pressure steam [071] spins [086] a turbine that turns [088] an electrical generator [074] to produce [058] output electrical power [082]. In order to make this entire process more efficient, a thermal insulator [138] surrounds the sulfur containment vessel [118] to prevent energy loss due to heat leaks.

In a prophetic teaching, the utility of a sulfur blanket [104] is demonstrated by considering DD fusion as the nuclear reaction [102]. DD fusion has two approximately equal probability channels shown in FIG. 1, one neutronic and the other aneutronic. The net energy gain from the neutronic reaction is 0.082 MeV plus 2.45 MeV for a total of 3.27 MeV. The net energy gain from the aneutronic reaction is 1.01 MeV plus 3.02 MeV for a total of 4.03 MeV. Therefore, the average net energy gain for DD fusion reactions is 3.65 MeV.

TABLE 1
Calculation of sulfur blanket [104] energy release
per captured [024] neutron [032].

| Absorbing Isotope | Sulfur-32 | Sulfur-33 | Sulfur-34 | Sulfur-36 |
|---|---|---|---|---|
| Natural Abundance | 94.99% | 0.75% | 4.25% | 0.01% |
| Capture Cross Section (barns) | 0.518 | 0.454 | 0.256 | 0.236 |
| Relative Capture Probability | 0.49204 | 0.00341 | 0.01088 | 0.00002 |
| Absolute Capture Probability | 97.17% | 0.67% | 2.15% | 0.00% |
| Capture Energy Gain (MeV) | 8.641 | 11.417 | 6.986 | 4.303 |
| Radioactive Isotope | | | Sulfur-35 | Sulfur-37 |
| Decay Product | | | Chlorine-35 | Chlorine-37 |
| Decay Energy Release (MeV) | | | 0.167 | 4.865 |
| Total Energy Release (MeV) | 8.641 | 11.417 | 7.153 | 9.169 |
| Weighted Release (MeV) | 8.397 | 0.077 | 0.154 | 0.000 |
| Release per Neutron (MeV) | | | | 8.628 |

Table 1 contains the input and calculated parameters that determine the energy release per captured [024] neutron [032] in a sulfur blanket [104]. The four columns of values contain the calculations parameters associated with the sulfur atoms [116] illustrated in FIG. 19. As indicated in FIG. 1, a neutron is emitted in DD fusion approximately 53.5% of the time. Therefore the average energy gain per fusion from neutron [032] capture [024] is 8.625×0.535=4.62 MeV. As shown in the previous paragraph, the average energy release per DD fusion is 3.65 MeV. Embodiments of an electrical power plant [002] including a sulfur blanket [104] enjoy an energy output increase factor of 2.27.

I. Electrical Energy Storage

There is enough sunlight and wind power on the planet to supply all of the energy needs of the world. The problem is that the availability of harvested power does not necessarily coincide with the instantaneous energy demands of consumers. An inexpensive and compact means of storing electrical power is one of the greatest challenges facing humanity.

Commercial nuclear fission reactors are capable of generating a steady electrical power level, but are not capable of tracking the minute-by-minute demand changes exhibited on electrical grids. A means of steadily charging and then quickly discharging stored energy as demand requires would also provide significant advantages.

An electrical power plant [002] based on DD nuclear fusion utilizing a sulfur blanket [104] can provide steady output electrical power [082] similar to that of a commercial nuclear fission reactor. The apparatus in FIG. 7 can be configured to follow hourly demand fluctuations, but cannot source high instantaneous peak electrical powers for such surge loads as starting a large electric motor.

One embodiment is to place an electrical battery between the electrical power plant [002] and an electrical load in order to provide such surge capacity. Another utility of this embodiment is to store electrical power from external power sources such as wind turbines and solar arrays.

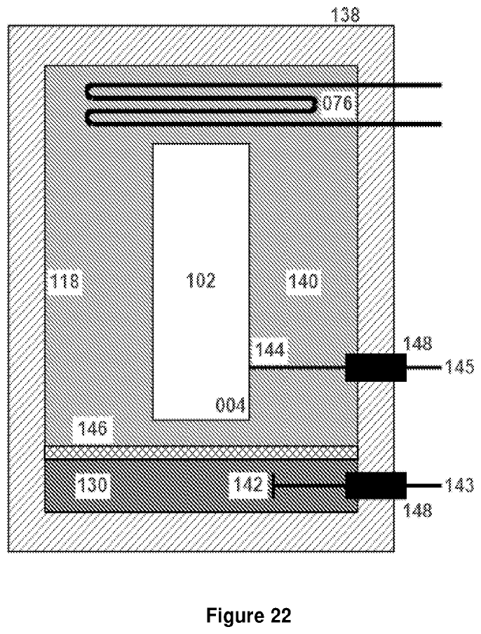

One type of electrical battery under study for many decades is the sulfur-sodium battery [120]. In an embodiment, the sulfur containment vessel [118] in FIG. 21 is modified to simultaneously produce a sulfur-sodium battery [120]. An embodiment wherein a sulfur blanket [104] also functions as a sulfur-sodium battery [120] is illustrated in FIG. 22.

A reservoir of molten sodium atoms [130] is separated from a molten sulfur-sodium mixture [140] by a solid electrolyte [146]. In an embodiment this solid electrolyte [146] is composed of the ceramic b″-alumina (BASE). The molten sodium atoms [130] serves as the anode [142] and the molten sulfur-sodium mixture [140] serves as the cathode [144]. The negative terminal [143] of this sulfur-sodium battery [156] is in electrical contact with the molten sodium [130] while the positive terminal [145] of the sulfur-sodium battery [120] is in electrical communication with the molten sulfur-sodium mixture [140]. In this scenario the sulfur containment vessel [118] walls are not in electrical communication with either the molten sodium [130], or sulfur-sodium mixture [140], or both. The negative terminal [143] and positive terminal [145] pass through the sulfur containment vessel [118] wall utilizing electrical insulators [148]. There can be more than one reservoir of sodium atoms [130], solid electrolyte [146], negative terminal [143], and/or positive terminal [145].

This embodiment can, in some cases, be advantageous over past embodiments of a sulfur-sodium battery [120] because of the elevated temperature required to operate such a battery [120] and the additional cost and complexity of providing the required heat and thermal insulation [138] as compared to other battery technologies. Because of the existence of the sulfur blanket [104] as a means of increasing the output electrical power [082] of a nuclear fusion electrical power plant [002], all of these additional costs and complexities already existed.

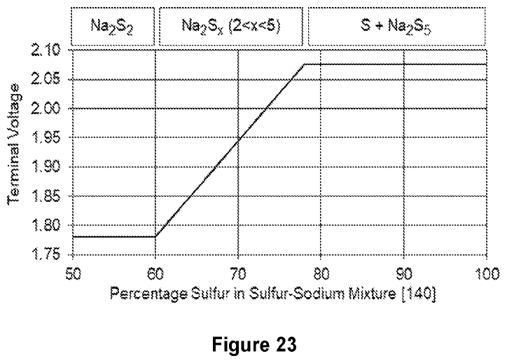

When the sulfur-sodium battery [120] is fully charged, substantially all of the sodium atoms [130] are in the sodium reservoir. As plotted in FIG. 23, when fully charged the voltage across the positive terminal [145] and negative terminal [143] is 2.076 Volts at a battery temperature of 350° C. As the sulfur-sodium battery [120] discharges electrical current across the terminals [143,145] sodium ions pass through the solid electrolyte [146] and preferentially form the compound Na₂S₅. Starting near the solid electrolyte [146] this compound gradually forms in progressively larger volume into the sulfur-sodium mixture [140] volume. When the percentage of sulfur atoms [116] in the sulfur-sodium mixture [140] reaches approximately 78%, the sulfur-sodium battery [120] voltage begins to decrease as first Na₂S₄, then Na₂S₃, and then Na₂S₂ begin to form. At a concentration of 60% sulfur atoms [116] in the sulfur-sodium mixture [140] substantially all of the sulfur-sodium mixture [140] is composed of Na₂S₂ and the sulfur-sodium battery [120] voltage becomes a constant 1.78 Volts.

J. Proton Conductors

There is a category of materials that are electrical insulators (do not conduct electrons) but instead conduct ions. In material science this category of materials is called ionic conductors. In applications such as fuel cells and batteries, these materials often play the role of an electrolyte. In the case of the sulfur-sodium battery [120], the ion being conducted in said solid electrolyte [146] illustrated in FIG. 22 are sodium ions Na+. In automotive oxygen sensors the ceramic electrolyte conducts oxygen ions O+. There is also a type of material that conducts protons [036], called proton conductors [100]. Given their chemical similarity, proton conductors [100] also conduct deuterons [028] and tritons [034].

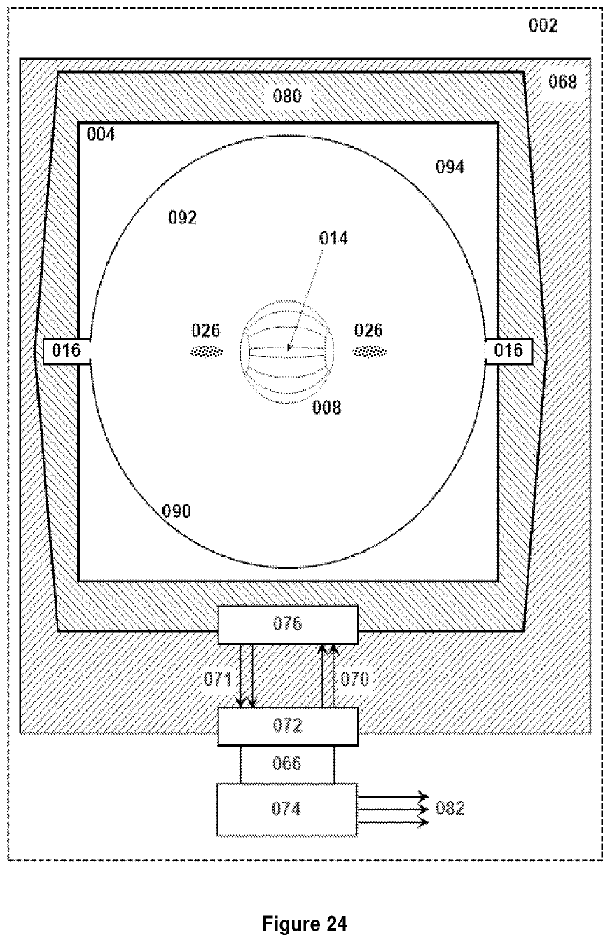

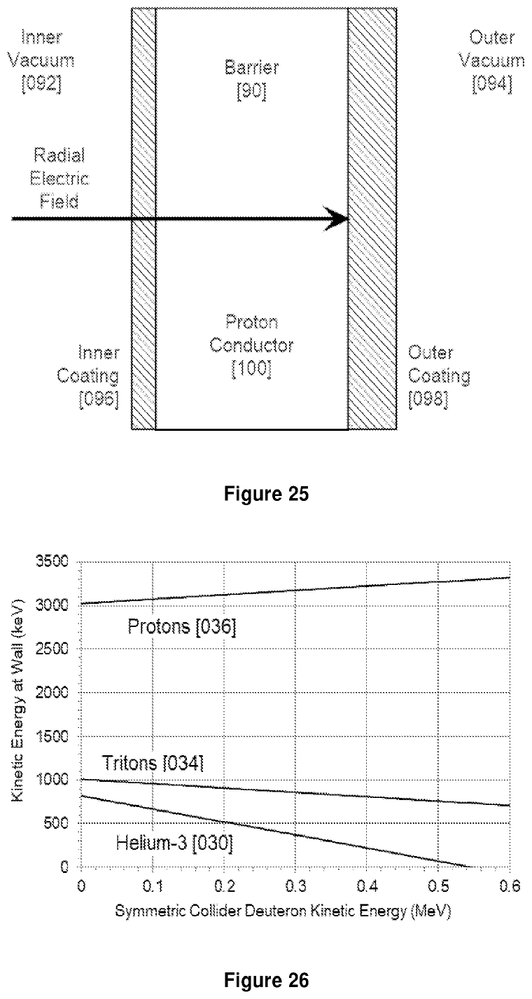

As illustrated in FIG. 24, consider an embodiment wherein a proton conductor [100] is used as barrier [090] to separate and inner vacuum [092] from and outer vacuum [094] contained within the vessel walls [004] of a vacuum vessel. In this embodiment the operation of the fusion reactions within the central region [014] no longer depend on the size and shape of the vacuum vessel wall [004], but instead on the size and shape of the barrier [090]. During the process of transforming [052] heat into output electrical power [082], the central electrode [008] is charged to a negative voltage. In an embodiment where the barrier [090] is comprised of a proton conductor [100], a conductive outer coating [098] on the radial outside surface of the barrier [090] can carry and equal and opposite charge of the central electrode [008]. These two charge distributions generate a substantially radial electric field that accelerate positively charged particles within the barrier [090], driving those positively charged particles to migrate toward the outer coating [098].

The use of ion pumps [044] as illustrated in FIG. 9 relies on vacuum ports [040] and vacuum lines [042] whose number and size are limited by a variety of considerations. One limitation is the distortion of radial electric fields generated by a negative voltage on the central electrode [008]. Another limitation is the loss of neutrons [032] from the blanket [080], wherein the larger and more numerous the vacuum lines [042] when passing through the blanket [080], the more neutrons [032] are lost before their kinetic energy is harvested [022] and they can undergo capture [024]. By limiting the size and number of vacuum lines [042] and vacuum ports [040], the conductance of gas flow from the central region [014] to the ion pumps [044] is also limited. Under such conditions, since the injection of deuteron beams [026] eventually represent the dominant material load in within the vacuum vessel wall [004], the vacuum pressure within central region [014] will rise as the level of fusion power generation increases. As a result, a more effective pumping mechanism for deuterons [028] and the resulting fusion products protons [036], tritons [034], and helium-3 nuclei [030] is indicated.

Under traditional usage of proton conductors in a fuel cell, hydrogen gas is on one side of the proton conductor while oxygen gas is flowed on the opposite side. Platinum-based catalysts and other less expensive substitute materials cause the hydrogen molecules to give up their electrons and conduct bare protons through the proton conductor. On the oxygen side catalysts are used to readily react the protons with oxygen molecules to form water molecules. The resulting water molecules are pumped away, maintaining a hydrogen population imbalance across the proton conductor. This imbalance, in conjunction with an operating temperature above 400 degrees Celsius, allows the protons to flow from one catalyst to the other, resulting in an electric current that can be used to power an electrical load or charge a battery.

In the embodiment illustrated in FIG. 24, no catalysts are required to pump protons [036], tritons [034], and helium-3 nuclei [030] from the inner vacuum [092] to toward the outer vacuum [094]. In this embodiment, this instant application teaches that said positively charged particles comprise protons [036] and tritons [034] and said barrier [090] conducts, at least one of said positively charged particles, from said inner vacuum [092] to said outer vacuum [094] while said electrical power plant [002] is generating [052] output electrical power [082]. First, these particles are already in the form of atoms not already bound into molecules. Second, the electric field between the central electrode [008] and the outer coating [098] of the barrier [090] comprised of a proton conductor [100] drives the pumping function. In one embodiment, this instant application teaches a barrier [090] comprised of a proton conductor [100]. In one embodiment, this instant application teaches an outer coating [098] comprised of stainless steel. Third, such catalysts are expensive. Fourth, the naturally occurring platinum isotope platinum-192 has a 10 barn cross section for capture [024] of neutrons [032]. This capture generates the radioactive isotope platinum-193 with a half-life of approximately 50 years. The avoidance of such radioactive activation of equipment is preferred. In one embodiment, this instant application teaches an electrical power plant [002] further including a vacuum vessel comprised of: a vessel wall [004] structured to contain an inner vacuum [092] and an outer vacuum [094]; a barrier [090] that has a substantially spherical shape within said vessel wall [004]; and a central region [014] radially inside of said barrier [090]; said barrier [090] structured such that: said inner vacuum [092] resides within said barrier [090]; said outer vacuum [094] resides between said vessel wall [004] and said barrier [090]; and said barrier [090] is attached to said one or more sources [006] of said ions [028] such that travel by said ions [028] is unimpeded to said central region [014] and the inner vacuum [092] and the outer vacuum [094] are separated; and said barrier [090] has a conductive outer coating [098] on a radial outside surface. In one embodiment, this instant application teaches an electrical power plant [002] further including; said negatively charged electrodes [008] constructed as a central, substantially spherical, electrode assembly concentric with said barrier [090], structured to repeatedly collide [018] as particle beams [026], with each other, and in said central region [014] of said vacuum vessel; an electrode charger [062] configured to maintain a voltage of said electrode assembly [008]; and at least one ion sputter vacuum pump [044].

A conductive inner coating [096] on the radial inside of the barrier [090] can be added in one embodiment in order to remove secondary electrons [038] emanating from the central electrode [008]. To remove secondary electrons [038], the thickness of this inner coating [096] can be as thin as 100 nanometers, or 0.1 microns. In one embodiment, this inner coating [096] is comprised of stainless steel. In another embodiment, this inner coating [096] can be comprised of titanium. In one embodiment, this instant application teaches a conductive inner coating [096] on a radial inside surface of said barrier [090]. In one embodiment, this instant application teaches an inner coating [096] comprised of at least one member of a group comprising carbon, chromium, manganese, copper, zinc, zirconium, niobium, molybdenum, palladium, silver, hafnium, tantalum, tungsten, rhenium, platinum, and gold.

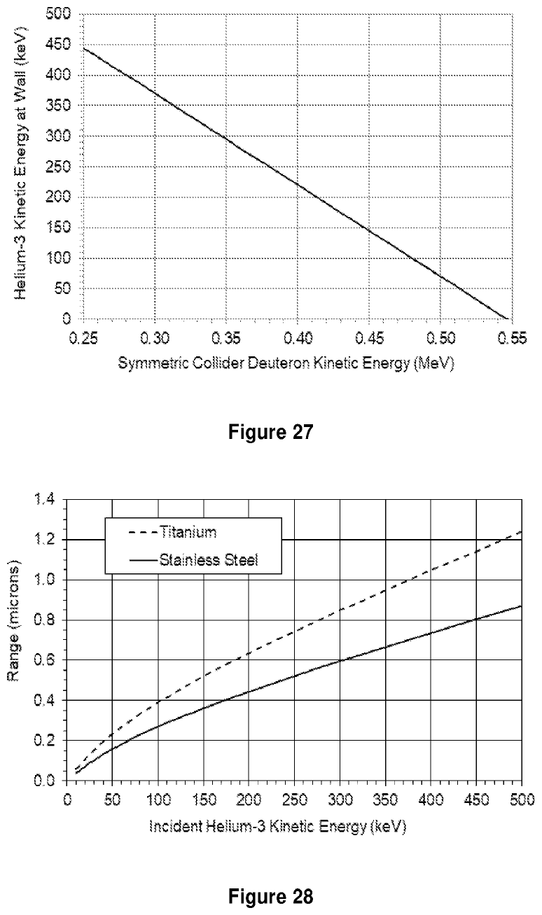

In an embodiment where the voltage of the outer coating [098] is equal to the ion source [006] voltage, the kinetic energy of positively charged particles generated by DD fusion are plotted in FIGS. 26 and 27. The kinetic energies of the protons [036], tritons [034], and helium-3 nuclei [030] as they approach the barrier [090] all depend on the kinetic energy of the deuteron beams [026] in the central region [014] while colliding [018]. FIG. 27 plots the same helium-3 data as appears in FIG. 26, but just in a finer kinetic energy scale.

In the case of helium-3 nuclei [030], their range into an inner coating [096] comprised of titanium or stainless steel is plotted in FIG. 28. Note that an incident kinetic energy of approximately 40 keV is desired in order for the helium-3 nucleus [030] to stop inside the proton conductor [100] material rather than inside the inner coating [096]. There are indications that although helium nuclei do not undergo standard proton conduction, their state of ionization might persist, and their migration will nonetheless be driven toward the outer vacuum [094].

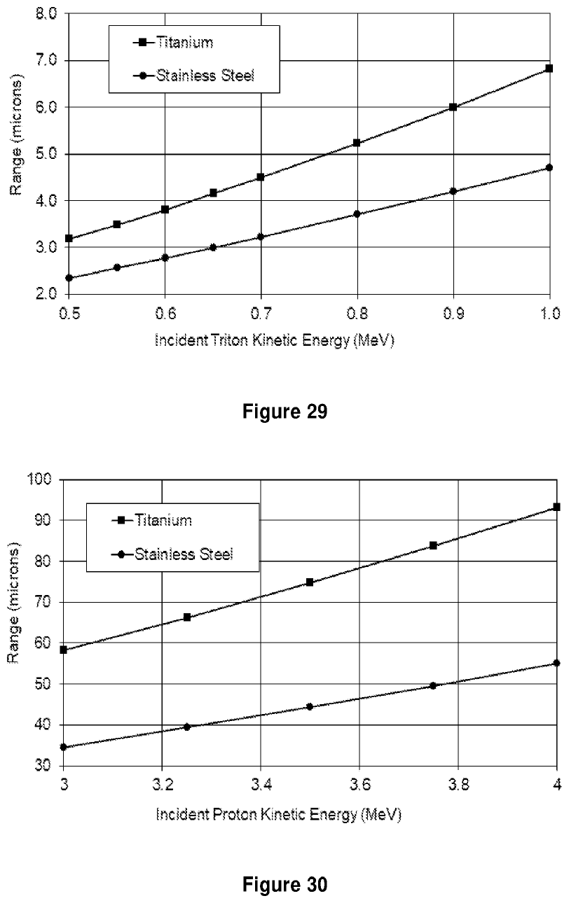

In the case of tritons [034], the expected kinetic energy into the barrier [090] is high enough the superior penetration ability of hydrogen ions indicate that their penetration ability will be far deeper. FIG. 29 contains a plot of triton [034] penetration into titanium and stainless steel as a function of their incident kinetic energy. According to FIG. 26, at a deuteron beam [026] kinetic energy at collisions of 500 keV, the triton [034] kinetic energy at the barrier [090] may be near 700 keV, and according to FIG. 29 the range in both titanium and stainless steel is greater than 2 microns.

The case of protons [036] is illustrated in FIG. 30. As expected, the range of the protons [036] generated by DD fusion events are measured in several tens of microns.

While the electrical power plant [002] is producing [058] output electrical power [082], the combination of heat from the DD fusion reactions and the secondary nuclear reactions in the sulfur blanket [104] cause the temperature of the electrical power plant [002] to increase. In one embodiment, the boiling of water [070] in a heat exchanger [076] to produce steam [071] maintains a constant sulfur blanket [104] temperature of greater than or equal to 400 degrees Celsius. In one embodiment the vacuum vessel wall [004] is in thermal communication with the sulfur blanket [104], indicating that said vessel wall [004] is at a temperature above 400 degrees Celsius while said electrical power plant [002] is generating [058] output electrical power [082]. At a minimum, the barrier [090] within the vacuum vessel wall [004] is in thermal communication with the vacuum vessel wall [004] via blackbody radiation. In one embodiment, this instant application teaches a barrier [090] at a temperature above 400 degrees Celsius while said electrical power plant [002] is generating [058] output electrical power [082].

In an embodiment wherein the ion beam sources [006] are the same voltage as the outer coating [098] of the barrier [090], deuterons [028] from the colliding [018] ion beams [026] that undergo Coulomb scattering reach the barrier [090] with zero kinetic energy. In this case the deuteron range is less than the thickness of the inner coating [096]. In an embodiment where 100 deuterons [028] undergo large Coulomb scattering deflections for every DD fusion event, the deuterium gas load caused by D2 molecule formation on the inner coating [096] would dominate the inner vacuum [092] pressure. There are several techniques for avoiding this situation. In one embodiment, the voltage of the ion sources [006] is biased negatively by enough voltage to cause said Coulomb scattered deuterons [028] to penetrate the inner coating [096] and stop within the proton conductor [100]. In this embodiment the barrier [090] conducts said deuterons [028] from said inner vacuum [092] to said outer vacuum [094] while said electrical power plant [002] is generating output electrical power [082].

At a temperature of 400 degrees Celsius, proton conductors [100] readily conduct all isotopes of hydrogen, although the speed of migration through the proton conductor [100] is slower for higher mass isotopes. Due to the radial electric field generated by the voltage difference between the central electrode [008] and the outer coating [098], the protons [036], deuterons [028], and tritons [034] eventually reach the outer coating [098]. In an embodiment where the outer coating [098] is conductive, these nuclei will pick up electrons and become neutral atoms. Once the population density of neutral atoms is sufficiently high, these neutral atoms will form the hydrogen gas molecules H2, D2, T2, HD, HT, and DT.

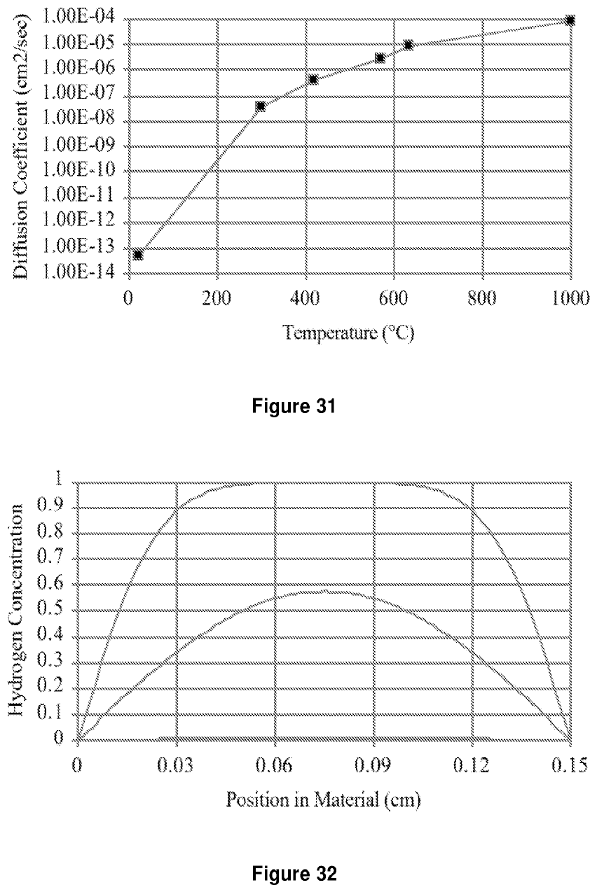

In an embodiment where the outer coating [098] is at a temperature greater than or equal to 400 degrees Celsius, these molecules will diffuse through the coating a preferentially desorb into the outer vacuum [094]. The H2 diffusion coefficient through stainless steel is plotted in FIG. 31 as a function of stainless steel temperature. Note that the vertical scale is logarithmic. The diffusion coefficient for other hydrogen molecules containing deuterons [028] or tritons [034] are smaller.

FIG. 32 is an illustration of hydrogen (H2) concentration across a plate of stainless steel as a function of time at a temperature of 500 degrees Celsius. In this calculation a vacuum is assumed on both sides of the stainless steel plate, where the initial hydrogen concentration is unity across the entire 0.15 cm thickness of the stainless steel plate. The curves in FIG. 32 show the expected H2 concentration profile after 1, 10, and 60 minutes (the 60 minute curve is barely distinguishable from the horizontal axis). Assuming that the diffusion of gas into the outer vacuum [094] is much greater than diffusion back through the barrier [090], the curves in FIG. 32 can represent the outer coating [098] if it were 0.075 cm thick and the midpoint of the plot is the location of the interface between the barrier [090] and the outer coating [098]. As indicated by FIG. 31, even at outer coating [098] temperatures of 250, 300, 350, 400, 450, 500, 550, 600, 650, and 700 degrees Celsius and greater, hydrogen gas of all isotopes will eventually end up in the outer vacuum [094]

K. Statement of Scope

In sum, it is important to recognize that this disclosure has been written as a thorough teaching rather than as a narrow dictate or disclaimer. Reference throughout this specification to “one embodiment”, “an embodiment”, or “a specific embodiment” means that a particular feature, structure, or characteristic described in connection with the embodiment is included in at least one embodiment and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment may be combined in any suitable manner with one or more other embodiments. It is to be understood that other variations and modifications of the embodiments described and illustrated herein are possible in light of the teachings herein and are to be considered as part of the spirit and scope of the present subject matter.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise. Variation from amounts specified in this teaching can be “about” or “substantially,” so as to accommodate tolerance for such as acceptable manufacturing tolerances.

The foregoing description of illustrated embodiments, including what is described in the Abstract and the Modes, and all disclosure and the implicated industrial applicability, are not intended to be exhaustive or to limit the subject matter to the precise forms disclosed herein. While specific embodiments of, and examples for, the subject matter are described herein for teaching-by-illustration purposes only, various equivalent modifications are possible within the spirit and scope of the present subject matter, as those skilled in the relevant art will recognize and appreciate. As indicated, these modifications may be made in light of the foregoing description of illustrated embodiments and are to be included, again, within the true spirit and scope of the subject matter disclosed herein.

1. An apparatus comprising:
an electrical power plant configured to produce output electrical power by bringing ions into collisions, wherein the ions are ions of one species, so as to induce nuclear fusion reactions, said electrical power plant including:
one or more sources of said ions;
one or more negatively charged electrodes constructed so as to:
accelerate said ions to kinetic energies sufficient to induce said nuclear fusion reactions;
focus said ions into said collisions in a manner devoid of magnetic fields; and
decelerate positively charged particles formed by said nuclear fusion reactions;
one or more blankets constructed to:
harvest kinetic energy from neutrons formed by said nuclear fusion reactions, said harvested kinetic energy converted into heat;
produce additional nuclear energy by capturing said neutrons;
convert said additional nuclear energy into additional heat within the blanket; and
accumulate as yet additional heat any remaining kinetic energy of said positively charged particles after said positively charged particles are decelerated; and
a transformer configured to transform said heat, said additional heat, and said yet additional heat within said blanket into said output electrical power, said transformer including:
a heat exchanger that accepts water and produces pressurized steam from the water;
a turbine that converts said pressurized steam into rotational energy; and
a generator coupled to said turbine that converts said rotational energy into said output electrical power.

2. The apparatus of claim 1, wherein the apparatus is devoid of a magnetic field that constrains a plasma comprised of said ions brought into said collisions.

3. The apparatus of claim 2, further including:
a vacuum vessel that has a substantially spherical shape, a vessel wall, and a central region, the vacuum vessel structured to contain a vacuum;
said negatively charged electrodes constructed as a central, substantially spherical, electrode assembly concentric with said vessel wall, structured to repeatedly collide said particle beams with each other in said central region of said vacuum vessel;
an electrode charger configured to maintain a voltage of said electrode assembly; and
at least one ion sputter vacuum pump.

4. The apparatus of claim 3, wherein said electrode assembly is coated with a carbon compound.

5. A process of producing output electrical power comprising:
colliding ions of one species so as to induce nuclear fusion reactions:
creating said ions;
electrostatically accelerating said ions to kinetic energies sufficient to induce said nuclear fusion reactions;
electrostatically focusing said ions into said collisions in a manner devoid of magnetic fields;
electrostatically recycling said kinetic energies from said ions that are deflected by elastic Coulomb scattering during said collisions;
electrostatically decelerating positively charged particles formed by said nuclear fusion reactions;
harvesting kinetic energy from neutrons formed by said nuclear fusion reactions, and converting said kinetic energy into heat;
capturing said neutrons via additional nuclear reactions to produce excess energy, and converting the excess energy into additional heat;
accumulating as yet additional heat any kinetic energy of said positively charged particles that remains after said decelerating; and
transforming said heat, said additional heat, and said yet additional heat into output electrical power.

6. The apparatus of claim 1, further including a vacuum vessel comprised of:
a vessel wall structured to contain an inner vacuum and an outer vacuum;
a barrier that has a substantially spherical shape within said vessel wall; and
a central region radially inside of said barrier;
said barrier structured such that:
said inner vacuum resides within said barrier;
said outer vacuum resides between said vessel wall and said barrier; and
said barrier is attached to said one or more sources of said ions such that travel by said ions is unimpeded to said central region and the inner vacuum and the outer vacuum are separated; and
said barrier has a conductive outer coating on a radial outside surface.

7. The apparatus of claim 6, further including;
said negatively charged electrodes constructed as a central, substantially spherical, electrode assembly concentric with said barrier, structured to repeatedly collide as particle beams, with each other, and in said central region of said vacuum vessel;
an electrode charger configured to maintain a voltage of said electrode assembly; and
at least one ion sputter vacuum pump.

8. The apparatus of claim 7, further including a conductive inner coating on a radial inside surface of said barrier.

9. The apparatus of claim 7, wherein said barrier is comprised of a proton conductor.

10. The apparatus of claim 7, wherein said outer coating is comprised of stainless steel.

11. The apparatus of claim 8, wherein said inner coating is comprised of titanium, or wherein said inner coating is comprised of at least one member of a group comprising carbon, chromium, manganese, copper, zinc, zirconium, niobium, molybdenum, palladium, silver, hafnium, tantalum, tungsten, rhenium, platinum, and gold.

12. The apparatus of claim 3, wherein said vessel wall is at a temperature above 400 degrees Celsius while said electrical power plant is generating output electrical power.

13. The apparatus of claim 6, wherein said positively charged particles comprise protons and tritons and said barrier conducts, at least one of said positively charged particles, from said inner vacuum to said outer vacuum while said electrical power plant is generating output electrical power.

14. The apparatus of any one of claims 1 and 6, wherein the ions are brought into said collisions as two particle beams, wherein:
both said particle beams consist essentially of no electrons;
both said particle beams have an equal average kinetic energy;
both said particle beams comprise deuterons; and
both said particle beams collide at an angle of 180 degrees.

15. The apparatus of claim 14, wherein said barrier conducts said deuterons from said inner vacuum to said outer vacuum while said electrical power plant is generating output electrical power.
